(19) United States
(12) Patent Application Publication
(10) Pub. No.: US 2025/0169403 A1
(43) Pub. Date: May 29, 2025

(54) SYSTEM AND METHOD OF PLANT CULTIVATION

(71) Applicant: Gardyn Inc., Bethesda, MD (US)

(72) Inventors: Lindsay Springer, West Seneca, NY (US); Francois-Xavier Rouxel, Bethesda, MD (US); Marie-Noelle Sinou Taillandier, Bethesda, MD (US)

(21) Appl. No.: 19/038,471

(22) Filed: Jan. 27, 2025

Related U.S. Application Data
(63) Continuation of application No. PCT/US2023/071114, filed on Jul. 27, 2023.
(63) Continuation-in-part of application No. 29/873,552, filed on Apr. 3, 2023.
(60) Provisional application No. 63/487,711, filed on Mar. 1, 2023.
(60) Provisional application No. 63/369,835, filed on Jul. 29, 2022.

(51) Int. Cl. A01G 9/029; A01C 1/04; A01G 27/06

(52) U.S. Cl. CPC A01G 9/0295; A01C 1/044; A01G 9/0297; A01G 27/06

(57) ABSTRACT

A plant-growing system can include a reservoir system and at least one pod. The reservoir system can include a base configured to hold a liquid and a top plate comprising at least one pod holder, where the top plate can be supported by the base. The at least one pod can be configured to be removably inserted in the at least one pod holder. The at least one pod can include a support plate, a wick comprising a first end and a second end, and a seed pad, where the wick can be positioned between the support plate and the seed pad.

### INCORPORATION BY REFERENCE TO ANY PRIORITY APPLICATIONS AND CROSS-REFERENCE TO RELATED APPLICATIONS

The present application is a continuation of PCT Application No. PCT/US2023/071114, filed Jul. 27, 2023 entitled “SYSTEM AND METHOD OF PLANT CULTIVATION”, which claims priority benefit to U.S. Provisional Application No. 63/487,711, filed Mar. 1, 2023, entitled “SYSTEMS AND METHODS OF PLANT CULTIVATION AND TARGETED PLANT IMPROVEMENTS” and U.S. Provisional Application No. 63/369,835, filed Jul. 29, 2022, entitled “SYSTEMS AND METHODS OF PLANT CULTIVATION AND TARGETED PLANT IMPROVEMENTS.” The present application is a continuation-in-part of U.S. Design application Ser. No. 29/873,552, filed Apr. 3, 2023, entitled “MICROGREEN ASSEMBLY AND COMPONENTS THEREOF.” Each of the aforementioned applications are hereby incorporated herein by reference in their entirety. Any and all applications for which a foreign or domestic priority claim is identified in the Application Data Sheet as filed with the present application are incorporated by reference under 37 CFR 1.57 and made a part of this specification.

Furthermore, the concepts described in this application are compatible with and can be used in conjunction with any combination of the embodiments, implementations, or features described in International Patent Publication No. WO 2020/076729 (the '729 publication), filed Oct. 7, 2019, entitled “Plant Growth Container,” the disclosure of which is hereby incorporated herein by reference in its entirety for all purposes. Some or all of the features described herein can be used or otherwise combined together with any of the features described in the '729 publication.

### FIELD

The present disclose generally relates to horticultural methods, systems, and apparatuses. More specifically, the present disclosure relates to plant-growing systems in which plants grow without soil.

### BACKGROUND

Techniques have been developed for growing plants without soil by utilizing mineral or bio-derived nutrient solutions in a water solvent. These techniques can provide a means of indoor or outdoor cultivation.

### SUMMARY

The systems, methods, and devices of this disclosure each have several innovative aspects, no single one of which is solely responsible for all of the desirable attributes disclosed herein.

A plant-growing system (e.g., the plant-growing system 100 in FIG. 1A) described herein allows for flexibility in growing a harvestable product (e.g., microgreens and/or baby greens). For example, the plant-growing system can provide producers with consistent high-quality plants without seeding and reduced food safety risks from seed handling. Also, the plant-growing system can save users time and know-how by eliminating seed weighing, seeding, watering, and/or light blocking trays. The plant-growing system can allow for custom sizing, shapes, and patterns of plant varieties (e.g., within seed pads). The plant-growing system can allow for inclusion of beneficial growing chemistries in the biopolymer binder to achieve improved germination, enhanced nutrition, and/or more effectively achieving desired plant growth goals.

Although certain examples are disclosed herein, inventive subject matter extends beyond the examples disclosed to other alternative examples or uses, and to modifications and equivalents thereof.

### BRIEF DESCRIPTION OF THE DRAWINGS

The drawings and the associated descriptions herein are provided to illustrate specific examples, embodiments, and/or implementations and are not intended to be limiting.

FIG. 1A illustrates a perspective view of an example plant-growing system, in accordance with some examples.

FIG. 1B illustrates a top view of the plant-growing system of FIG. 1A.

FIG. 1C illustrates a front view of the plant-growing system of FIG. 1A.

FIG. 1D illustrates a side view of the plant-growing system of FIG. 1A.

FIG. 2A illustrates an exploded view of an example grow pod, in accordance with some examples.

FIG. 2B illustrates a partially exploded view of the grow pod of FIG. 2A.

FIG. 2C illustrates the fully-assembled grow pod of FIG. 2A.

FIG. 3A illustrates a perspective view of an example support plate, in accordance with some examples.

FIG. 3B illustrates a top view of the support plate of FIG. 3A.

FIG. 3C illustrates a bottom view of the support plate of FIG. 3A.

FIG. 3D illustrates a side view of the support plate of FIG. 3A.

FIG. 4A illustrates a perspective view of an example reservoir system, in accordance with some examples.

FIG. 4B illustrates a top view of the reservoir system of FIG. 4A.

FIG. 4C illustrates a bottom view of the reservoir system of FIG. 4A.

FIG. 4D illustrates a front view of the reservoir system of FIG. 4A.

FIG. 4E illustrates a side view of the reservoir system of FIG. 4A.

FIG. 4F illustrates a cross-sectional front view of the reservoir system of FIG. 4A taken across the line 4F-4F shown in FIG. 4A.

FIG. 4G illustrates a cross-sectional side view of the reservoir system of FIG. 4A taken across the line 4G-4G shown in FIG. 4A.

FIG. 5A illustrates an example grow pod being inserted into a reservoir system.

FIG. 5B illustrates an enlarged view of a portion of FIG. 5A.

FIG. 6A illustrates an exploded view of a grow pod and an example seed receptacle, in accordance with some examples.

FIG. 6B illustrates the grow pod inserted into the seed receptacle shown in FIG. 6A.

FIG. 7 is a flow diagram illustrative of an example method of assembling a seed pad.

### DETAILED DESCRIPTION

Microgreens are the young, sprouted plants that emerge with cotyledons upon seed germination and are often matured to true leaves stage, for example, after 6-14 days typically. Additionally, allowing the microgreens to mature (e.g., in the presence of plant nutrients) over one-four or more weeks will typically result in the microgreens turning into baby greens, which are larger-sized young, immature plants with greater leaf surface area than microgreens. Baby greens are commonly included in bagged salad mixes, which have dominated the fresh produce market and are expected to reach a market of 20.3 billion by 2028 with an CAGR of 8.2%. The terms “microgreens” and/or “baby greens” refer to descriptive market terminology. Any use of microgreens or baby greens should be interpreted broadly to mean any plant capable of growing by the systems and/or methods described herein.

Microgreens and baby greens have gained considerable traction in B2B and B2C markets due to their favorable health properties, intense flavors, and colors, and propensity to elevate culinary dishes. For example, red cabbage microgreens contain over 40 times the vitamin E content of its mature counterpart. Red cabbage microgreens additionally contain higher levels of numerous glucosinolate compounds which provide more intense flavor profiles in addition to health benefits when compared to mature red cabbage (for example, on a weight basis). With an alluring nutritional profile, flavor, and textural qualities-microgreens also boast short production cycles of approximately 5-28 days—with many common varieties harvested within approximately 6-10 days. This makes microgreens a fast route to nutritious, flavorful, beautiful plant-based nutrition. Similar to baby greens, the microgreen market is expected to experience an over 8% CAGR.

However, due to the tender nature of young plants, the shelf life of microgreens and baby greens are relatively short compared to mature plant counterparts. This high vulnerability to become food waste makes them excellent candidates for hyperlocal production (e.g., grown at the place of consumption) so as to remove or limit spoilage risks associated with the packaging and transporting of the microgreens and baby greens. For instance, the hyperlocal production model of microgreens and baby greens not only reduces food waste but can significantly or completely reduce the plastic waste associated with bagged salads and microgreen claim shell packaging while significantly lowering the carbon footprint of the supply chain. Given that nutrients tend to degrade over time after harvest and throughout transport, hyperlocal production systems can ensure that peak nutritive value is achieved at the point of consumption.

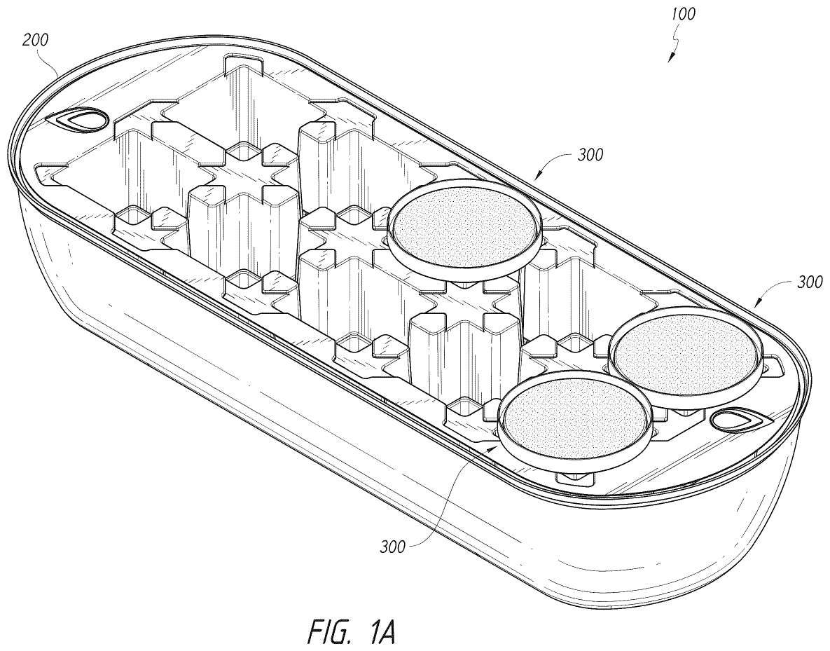

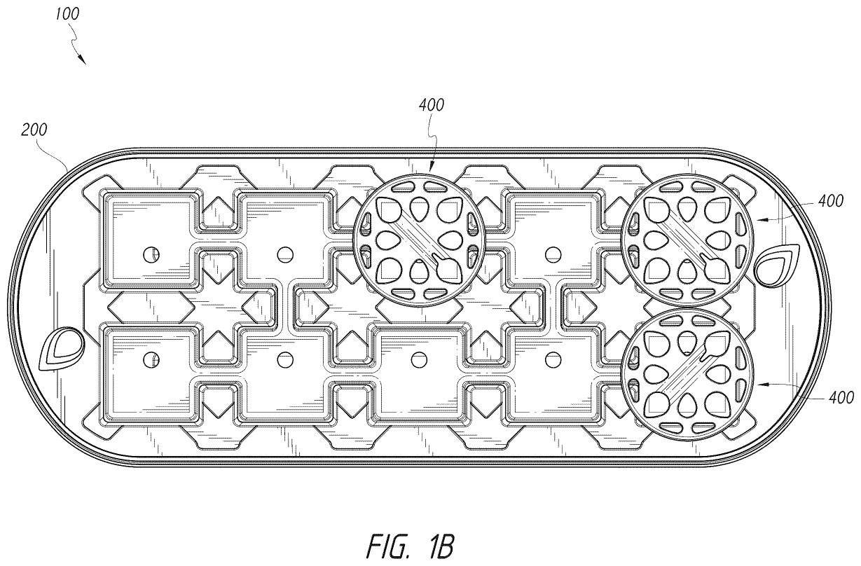

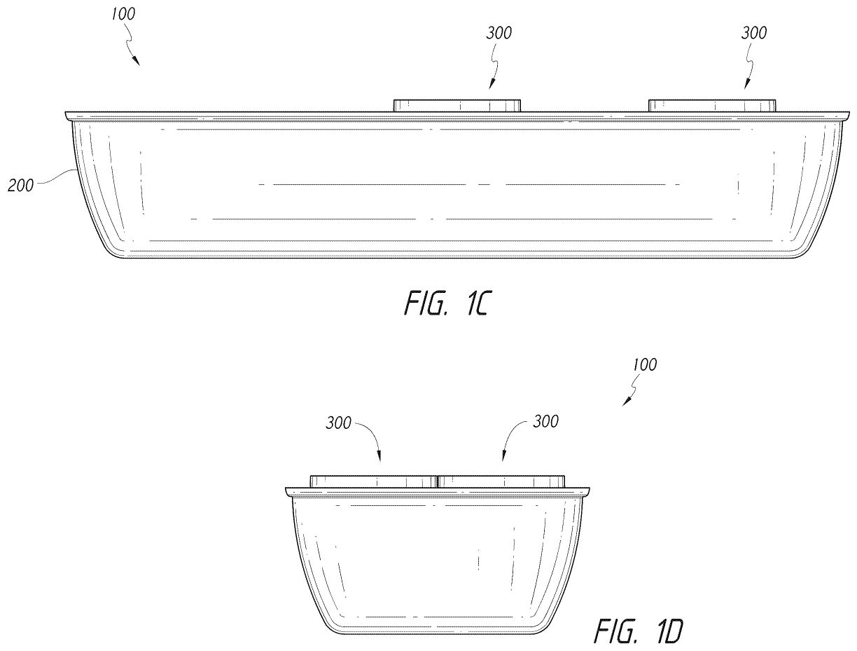

While hyperlocal production of microgreens and baby greens may offer significant advantages to health and the environment, their cultivation by traditional means requires some knowledge of plants, indoor farming, food safety, and produce quality. While the food service industry and households would benefit from growing microgreens hyper locally, the biggest barriers to entry are knowledge, time, and growing equipment. The described plant-growing system (e.g., the plant-growing system 100 in FIG. 1A) system seeks to eliminate these barriers and enable fast, easy, high-quality microgreen and baby green cultivation.

The plant-growing system described herein can significantly simply the microgreen cultivation process and eliminate one or more of the time consuming and difficult user tasks traditionally associated with microgreen cultivation.

### Example Plant Growing System

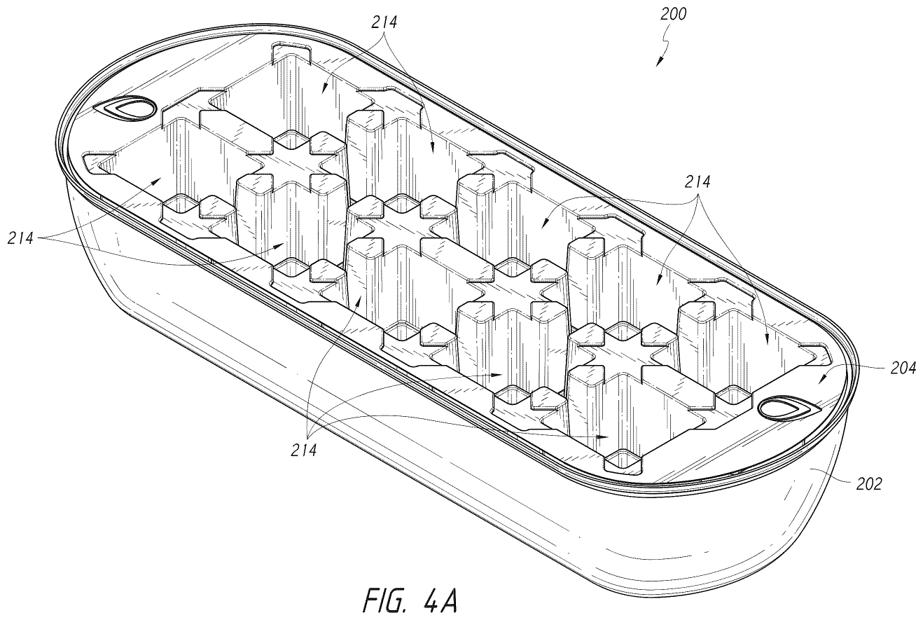

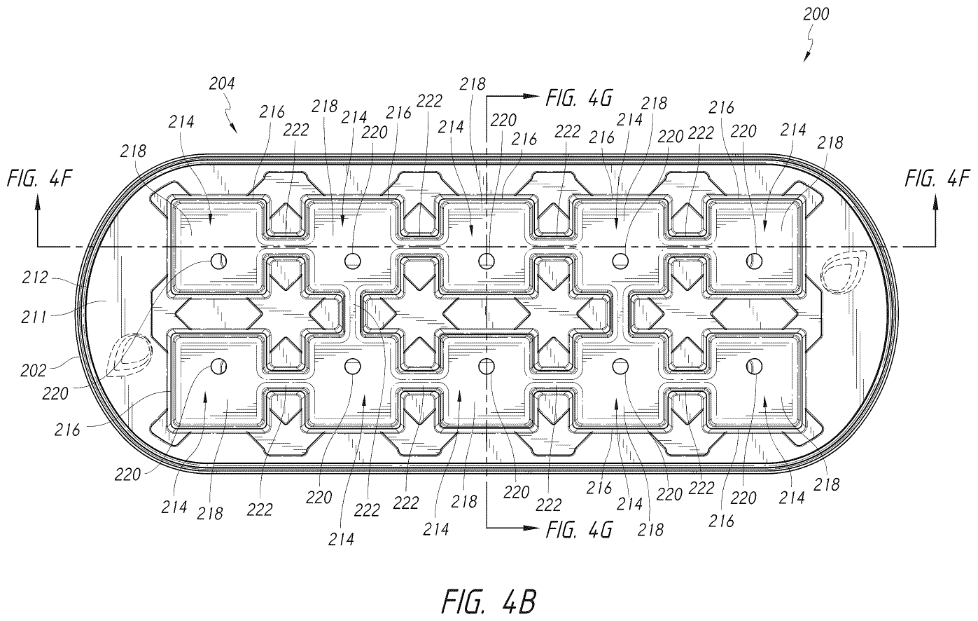

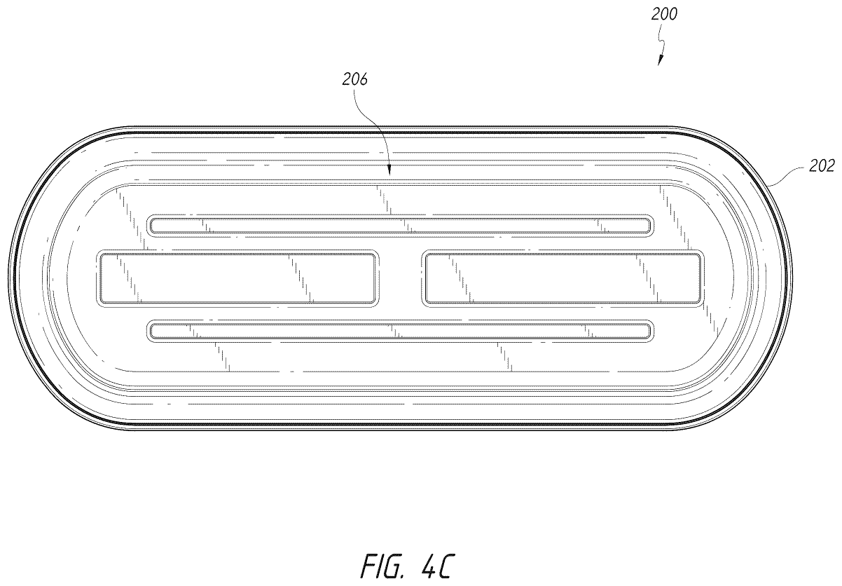

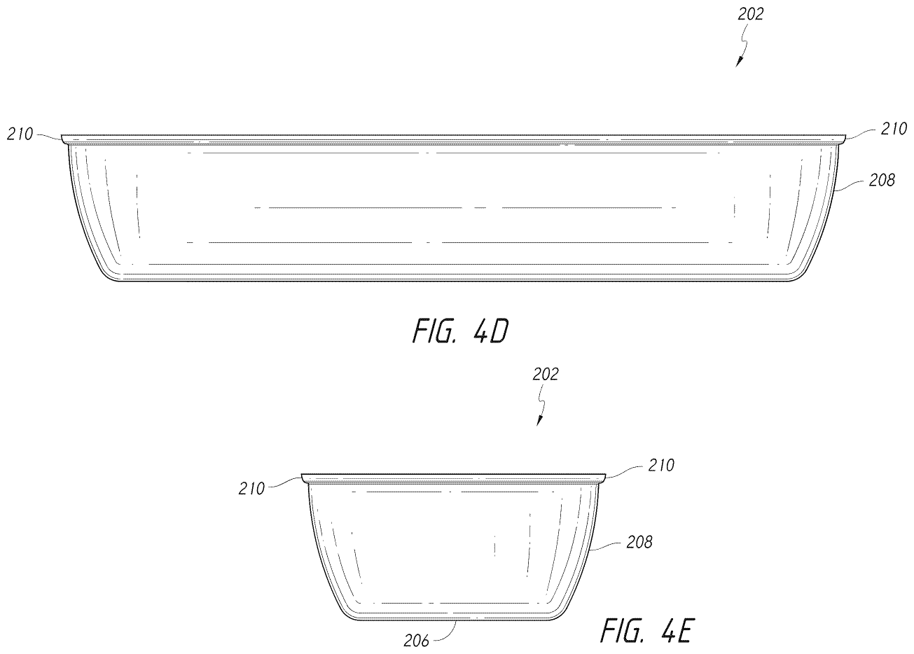

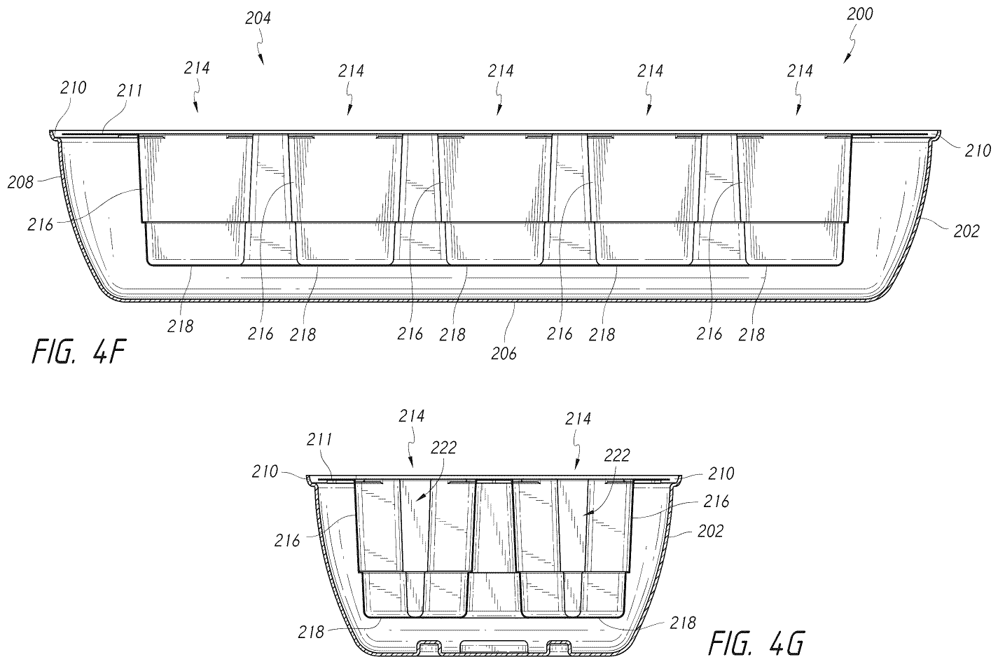

FIG. 1A illustrates a perspective view of an example plant-growing system 100, in accordance with some examples. FIGS. 1B-1D illustrate a top, front, and side view of the plant-growing system 100 respectively. The plant-growing system 100 includes a reservoir system 200 and a plurality of grow pods 300. In the plant-growing system 100, the plurality of grow pods 300 are physically supported by, and configured to extract liquid from, the reservoir system 200. The extracted liquid allows the grow prods to grow plants (e.g., microgreens and/or baby greens). Liquid, as the term is used herein, generally refers to water (e.g., H₂O) and/or water with added plant nutrients, chemicals, salts, etc. The reservoir system 200 is described further with reference to FIGS. 4A-4F.

The plant-growing system 100 represents an example plant-growing system configured to hold up to 10 grow pods 300. However, other examples may be configured to house fewer, additional, or different components (e.g., grow pods 300) or arrangements (e.g., the reservoir 200 can be shaped in a circle, square, triangle, or other configuration). The plant-growing system 100 can be configured to facilitate plant production (for example, production of microgreens and/or baby greens) while eliminating significant friction points commonly associated with plant production in B2B and B2C markets. For example, the plant production can be hyperlocal, or grown at or near the place of consumption. The example plant-growing systems and methods described herein are additionally amenable to adding functional compounds to the plant cultivation system by a biopolymer binder in order to, for example, enhance germination and/or plant health properties. The biopolymer binder is described further in the composition section.

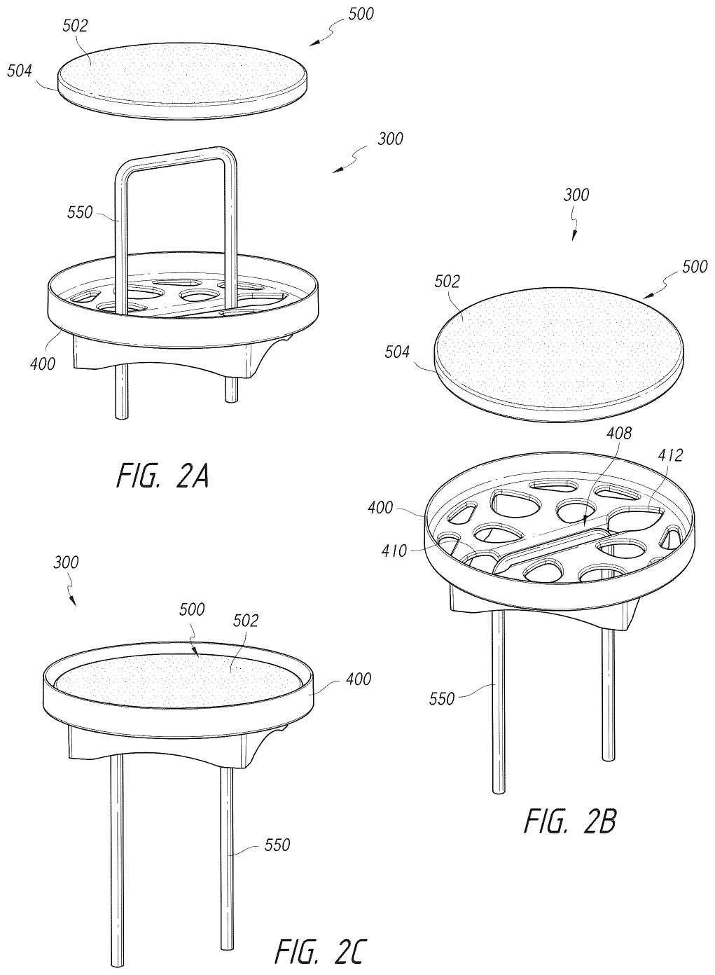

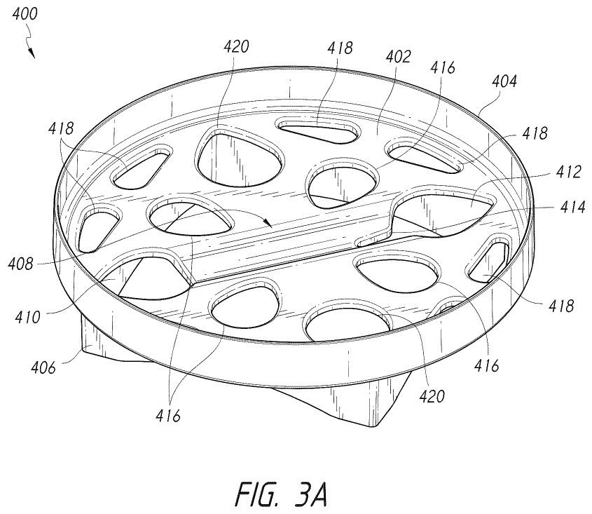

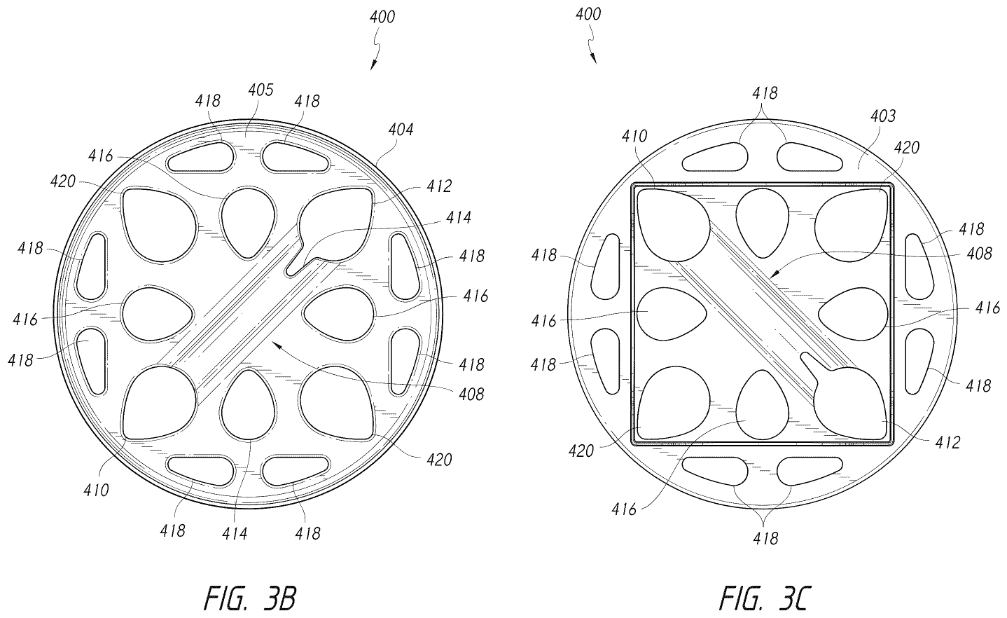

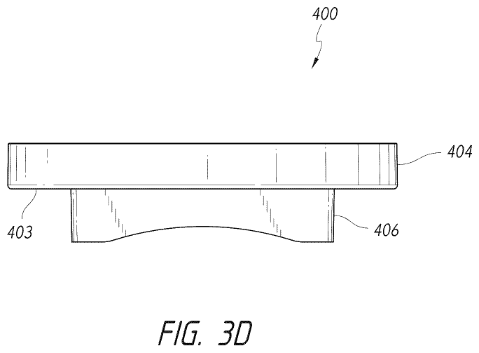

FIGS. 2A-2C illustrate an example grow pod 300, in accordance with some examples. FIG. 2A illustrates a perspective exploded view of the grow pod 300, FIG. 2B illustrates a partially exploded view of the grow pod 300, and FIG. 2C illustrates a fully assembled grow pod 300. Each grow pod 300 can include a support plate 400, a seed pad 500, and a wick 550. The support plate 400 is configured to house the seed pad 500 and a portion of the wick 550. The support plate 400 is described further herein with reference to at least FIGS. 3A-3D.

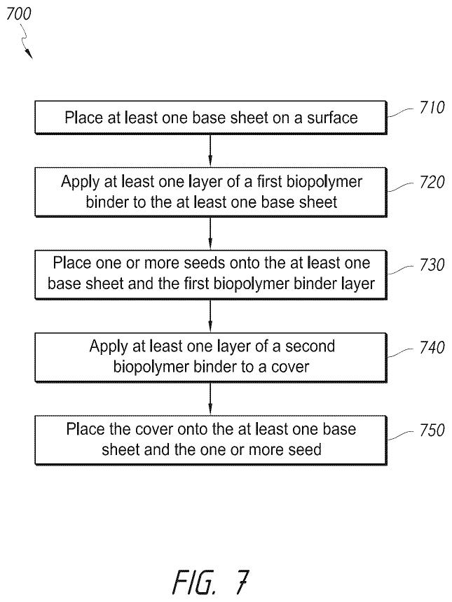

The seed pad 500 (also referred to herein as the “grow mat 500”) is configured to produce one or more plants or microgreens, when used with the plant-growing system 100. The seed pad 500 can include one or more base sheets 504, one or more seeds (not shown), and a cover 502. As described further herein with reference to the method 700 of FIG. 7, the combination of the base sheets 504 and the cover 502 provide a support structure for the seeds in a completed seed pad 500. The base sheets 504 can form the base of the seed pad 500 and the cover 502 can form the top of the seed pad 500, with the seeds positioned therebetween. The combination of the base sheets 504 and the cover 502 (e.g., also with a biopolymer binder in some cases) can allow the seeds to be easily transported in the form of a completed seed pad 500. In some implementations, the seed pad 500 can include a hydrated food grade biopolymer binder (also referred to herein as the “biopolymer binder”). The biopolymer binder can be positioned between the base sheets 504 and the cover 502 and allow the base sheets 504 and the cover 502 to be coupled together, with the seeds therebetween.

The one or more base sheets 504 act as a base for the seeds in the seed pad 500 and form the bottom portion of the seed pad 500. In some implementations, the base sheets 504 may be a grow medium configured to promote the growth of the one or more seeds into plants. For example, the base sheets 504 can be made of bamboo, hemp, jute, polyfil, wood shavings (e.g., compact/compressed wood shaving), a composition of the foregoing, and/or the like. When acting as a grow medium, the base sheets 504 can support the growth of the plants in the grow pod 300. For example, the base sheets 504 can provide an initial base for the plant root to anchor. In some cases, the base sheets 504 may provide nutrients to help promote healthy growth of the plants. For example, the nutrients can be provided to the plants as a result of the organic material the base sheets 504 are made of. In another example, the base sheets 504 can be treated to provide additional nutrients to the plants. In some implementations, the base sheets 504 can be treated with the biopolymer binder, as described herein. In some implementations, the composition of the base sheets 504 can vary depending on the type of plant being cultivated in the grow pod 300. For example, different plants may have varying requirements for water retention, aeration, and nutrient availability, which can be promoted by base sheets 504 of specific compositions.

Each seed pad 500 can include one or more seeds of a desired variety (e.g., corresponding to a single type of plant) for plant/microgreen production in the grow pod 300. In some implementations, the seed pad 500 can include one or more seeds of multiple desired varieties (e.g., corresponding to multiple different types of plants). The seed(s) can be positioned on the base sheets 504 and covered by the cover 502. Examples of seeds that can be in the seed pad 500 can include, but are not limited to: kale, alfalfa, pea, anise, borage, buckwheat, dandelion, brussels sprout, Komatsuna, Mint, Leek, asparagus, Lemongrass, sunflowers, Orach, Tangerine, Spinach, Pumpkin, Rutabaga, Purslane, Oregano, Parsley, Sage, Nasturtium, Lovage, Tarragon, Thyme, Turnip, Marigold, Wasabi, Saltwort, Sesame, Wheatgrass, Sorrel, Marjoram, Sambuca, mustards, or the like seeds. Further, the seed pad 500 can include seeds of any of the following families of plants: the Amaranthaceae family (e.g., amaranth, beets, celosia, cilantro, Fenugreek, Kohlrabi, Hemp, Flaxseed, collard, clover, chervil, chia, chard, quinoa, and spinach), the Amaryllidaceae family (e.g., chives, garlic, leeks, and onions), the Apiaceae family (e.g., carrot, celery, dill, and fennel), the Asteraceae family (e.g., chicory, endive, lettuce, and radicchio), the Brassicaceae family (e.g., arugula, broccoli, cabbage, cauliflower, radish, and watercress), the Cucurbitaceae family (e.g., cucumbers, melons, and squashes), the Lamiaceae family (e.g., most common herbs like mint, basil, rosemary, sage, and oregano), and the Poaceae family (e.g., grasses and cereals like barley, corn, rice, oats, and wheatgrass, as well as legumes including beans, chickpeas, and lentils).

The cover 502 is the top portion of the seed pad 500. For example, the cover 502 and the base sheets 504 form the exterior of the seed pad 500 and provide a housing for the seeds. In this arrangement, the one or more seeds can be transported as a collective unit, contained within the seed pad 500 (e.g., between the base sheets 504 and the cover 502). In some implementations, the cover 502 can be made of a paper or wood pulp material. For example, the cover 502 can be produced from de novo or recycled organic materials. In some implementations, the cover 502 can be one or more sheets of paper. In some implementations, the cover 502 can be coupled to the base sheet via a biopolymer binder, as explained herein. In some implementations, the cover 502 can protect the seeds from being exposed to light or reduce the amount of the light the seeds are exposed to. For example, some seeds may require or benefit from darkness during at least the germination stage. Additionally, protection from light and/or the external environment can prevent the seeds from becoming too dry. As explained herein, as the seeds germinate and grow, the cotyledons of the plant can push out from the seed coat. At this point, the cover 502 can be easily removed and/or the cover 502 may be fall off naturally from the grow pods 300, thus exposing the new plants to additional light.

The biopolymer binder, for example, can include water and one or more biopolymers. The biopolymer binder can be used to bind or couple the various components of the seed pad 500 together. For example, the biopolymer binder can be used to couple the base sheets 504 with the seeds and/or the cover 502 with the seeds positioned between the base sheets 504 and the cover 502 (e.g., to form a seed pad 500). In this manner, the biopolymer binder functions as a binder or adhesive in the seed pad 500. For example, having the base sheets 504 and cover 502 coupled together allows the seed pad 500 to be transported with a reduced chance of losing seeds from the seed pad 500. In some cases, the biopolymer binder is configured to dissolve in the presence of liquid, such as water, such that the components of the seed pad 500 can separate when hydrated. Generally, the biopolymer binder is formed from natural, renewable, and biodegradable sources. In some implementations, the biopolymer can be one or a combination of: carboxymethyl cellulose, guar gum, arabica gum, carrageenan, locust bean gum, or the like. In some implementations, the biopolymer binder can be functionalized with additional chemistries to infer beneficial growing and health properties to the plant in the grow pod 300, as described further below. Use of a biopolymer binder in the seed pad 500, as opposed to a synthetic binder, can provide certain advantages. For example, the biopolymer binder can be biodegradable, renewable, and can have a low environmental impact. These properties can be particularly desirable when used in a plant growth system, such as the plant-growing system 100, where the microgreens and baby greens can be grown for human consumption. In contrast, a synthetic binder may not be biodegradable or renewable, and can have a higher environmental impact compared to a biopolymer binder. In some implementations, the biopolymer binder can enhance germination and/or plant health properties as the plants grow from the grow pods 300.

FIG. 7 shows a flow diagram illustrating an implementation of a method 700 of assembling the seed pad 500. In one implementation, the seed pad 500 can be manufactured by assembling the components of the seed pad 500 on the one or more base sheets 504. It is recognized that there are other implementations of the method which may exclude some of the blocks shown and/or may include additional blocks not shown. Additionally, the blocks discussed may be combined, separated into sub-blocks, and/or rearranged to be completed in a different order and/or in parallel.

The method 700 can begin at block 710, when at least one base sheet is placed on a surface. For example, at least one base sheet can be positioned on a flat surface (e.g., a table) so that a bottom surface of the base sheet touches the flat surface, and a top surface of the base sheet faces up towards the sky.

At block 720, a first layer of a first biopolymer binder can be applied to the base sheet (e.g., on a top surface of the base sheet). The biopolymer binder can be applied using a brush, roller, spray, and/or the like. In some implementations, more than one layer of the first biopolymer binder can be applied to the top surface of the base sheet.

At block 730, one or more seeds can be deposited or placed onto the base sheet and the first biopolymer binder layer (e.g., at a desired seeding density)). The desired seeding density can vary based on a number of factors, including, for example, the type of plant corresponding to the seeds, the size of the seed pad 500, the type of plant-growing system (e.g., the plant-growing system 100) the seed pad 500 is intended to be used in, whether the plants are intended to be harvested as microgreens or baby greens, and/or the like. The seeds can be deposited via a user's hands, drop seeder, auto-seeder, and/or the like. In some implementations, use of an auto-seeder can provide certain benefits. For example, an auto-seeder can limit the amount of contact between a user's hand and the seeds (e.g., so certain human oils or bacteria aren't transferred to the seeds which may limit growth of the plant). In another example, an auto-seeder can help ensure a desired number of seeds and/or seed density are placed on the base sheets 504. The desired number of seeds can correspond to the desired seeding density. In some cases, too many seeds in the seed pad 500 can impact the overall growth of the microgreens in the grow pod 300. In some cases, too few seeds in the seed pad 500 can result in an insufficient number of microgreens being grown in the grow pod 300.

At block 740, a second layer of a second biopolymer binder can be applied to a first, or bottom, surface of the cover 502. The biopolymer binder can be applied using a brush, roller, spray, and/or the like. In some implementations, more than one layer of the second biopolymer binder can be applied to the bottom surface of the cover 502. In some implementations, the second biopolymer binder is the same as the first biopolymer. In other implementations, the second biopolymer binder is different from the first biopolymer binder.

At block 750, the cover 502 can then be placed on top of the seeded base sheet so that the first, or bottom, surface of the cover 502 faces and/or touches the one or more seeds which rest on the top surface of the base sheet, thus forming the seed pad 500. In this arrangement, the seeds are positioned between two layers of biopolymer binder, and the base sheets 504 and the cover 502 on the outside of the two layers of biopolymer binder so that the cover 502 and base sheets 504 sandwich the seeds. In some implementations, pressure may be applied to the cover 502 during assembly to ensure the seed pad 500 is compact (e.g., to reduce risk of seeds moving or falling out). For example, the cover 502 can be pressed towards the base sheet when the cover 502 is placed.

In some implementations, the seed pad 500 can be assembled individually (e.g., in a size that can be used in the grow pod 300). In other implementations, the seed pad 500 can be assembled from large base sheet(s) and a large cover 502, and the desired shape of the seed pad 500 can be cut out of the larger assembled seed pads. In some cases, the seed pad 500 may be shaped to correspond to the shape of the support plate 400 (e.g., the seed pad 500 can be approximately the same shape and size as a base 402 of the support plate 400). For example, the seed pad 500 circular, square, oval, rectangular, triangular, and/or the like. Generally, the seed pad 500 is shaped for the desired support plate 400 to which the seed pad 500 is configured to interface with.

In some implementations, the seed pad 500 (e.g., including at least one base sheet, biopolymer binder layer(s), one or more seeds, and the cover 502) is dried prior to use in the grow pod 300. When mass produced, the seed pads 500 can be cut into desired shapes prior to or after the seed pads 500 are dried. In implementations, the seed pad 500 may not include any interruptions, such as holes, slots, rips, and/or the like within any area contained by the perimeter of the seed pad 500. In some implementations, due to the organic nature of the seed pad 500, there may be perforations within the seed pad 500.

In the assembled grow pod 300, the wick 550 is positioned between the support plate 400 and the seed pad 500. The wick 550 is configured to wick or draw liquid from the reservoir system 200 and deliver the liquid to the grow pod 300 (e.g., for the seed pad 500 and the plant(s) that sprout). The wick 550 can be any suitable wicking material, such as bamboo, polypropylene, nylon, cotton, wool-pressed felt, and/or the like. In some implementations, the wick is configured to have a minimal length such that the wick can have at least one end in contact with the liquid of the reservoir system 200 when the grow pod 300 is positioned in the reservoir system 200. In some implementations, the wick can be between 2 inches and 16 inches long (e.g., less than 16 inches, less that 14 inches, less than 12 inches, less than 10 inches, less than 8 inches, less than 6 inches, less than 4 inches, and/or the like). The wick 550 can be any diameter. In some implementations, the wick 550 has a diameter of 2 millimeters or greater.

In some implementations, the wick 550 may comprise a rigid wick structure with minimal or no flexibility. For example, a bamboo wick may have a rigid structure. In some cases, a rigid wick may be configured to withstand a range of forces with minimal elastic deformation and the rigid wick may be configured to return to its original shape after a force (e.g., within the range of forces) is applied. In some implementations, the wick 550 may comprise a flexible wick structure. For example, a polypropylene wick may have a flexible structure. In some cases, a flexible wick may be configured to bend or change shape when a force is applied to the flexible wick. For example, when the flexible wick is inserted into a grow pod, the flexible wick can change shape to conform to a new shape based on supporting surface structures (e.g., the support plate 400) in contact with the flexible wick.

FIG. 3A illustrates a perspective view of a support plate 400. FIGS. 3B-3D illustrate a front, back, and side view of the support plate 400, respectively. As noted herein, the support plate 400 forms a portion of the grow pod 300. The support plate 400 can include a base 402, a rim 404, and a base support 406. The support plate 400 can be any suitable material, such as a silicone, polymer, metal, a combination thereof, and/or the like. The support plate 400 should be sufficiently rigid such that the support plate 400 can support the seed pad 500 and/or a small plant. In some implementations, the support plate 400 is water-resistant.

The base 402 is configured to support the seed pad 500 and wick 550 of the grow pod 300. The base 402 also allows the grow pod 300 to be suspended above a pod holder 214 of the reservoir system 200, as described herein. Once a plant begins to sprout from the seed pad 500, the base 402 supports the plant. The base 402 can be any shape, such as, a square, rectangle, circle, triangle, oval, and/or the like. In some cases, a substantially circular base 402 may provide advantages, such as, for example, promoting an even distribution of water in the grow pod 300, whereas a square-shaped base 402 may result in less water being received in the corners of base 402 (e.g., as compared to the center of the edges of the square-shaped base 402, or any other point on the square-shaped base 402). The base 402 can include a wick recess 408, a first wick hole 410, and a second wick hole 412. When the grow pod 300 is assembled, the wick 550 is positioned in the wick recess 408 of the support plate 400 and the ends of the wick 550 extend through the wick holes 410, 412. FIG. 2B, for example, illustrates a partially assembled grow pod 300, with the wick 550 positioned in the wick recess 408. The wick recess 408 can be a channel or groove extending along the center of the support plate 400 between the first wick hole 410 and the second wick hole 412. In some implementations, the wick recess 408 allows the wick 550 to be positioned in the support plate 400 such that a top portion of the wick 550 is generally aligned with a planar projection defined by the base 402. In this arrangement, the seed pad 500 can be substantially level when positioned on the base 402 and the wick 550. In some implementations, a portion of the wick 550 may extend above the plane defined by the base 402. It is desirable for the seed pad 500 to be in contact with a portion of the wick 550 in the assembled grow pod 300 so that water can flow to the seed pad 500 and the seeds contained therein. For example, substantially consistent physical contact between the seed pad 500 and at least a portion of the wick 550 can help ensure that optimal of sufficient flow of liquid is provided to the seed pad 500 and the seeds contained therein, which can improve the growing conditions for the plants in the grow pod 300. The base support 402 can assist with holding the wick 550 in contact with the seed pad 500.

The wick holes 410, 412 allow both ends of the wick 550 to extend through the support plate 400 and down into the reservoir system 200 (e.g., where liquid is stored) when the grow pods 300 are positioned in the reservoir system 200. The wick holes 410, 412 can be any suitable shape, such as, a square, rectangle, circle, oval, and/or the like. In the embodiment illustrated in FIGS. 3A-3D, the wick holes 410, 412 are shaped like leaves or tear-drops. In some implementations, one or both of the wick holes 410, 412 can include a retention slot 414. For example, as shown in FIG. 3B, the second wick hole 412 includes the retention slot 414. The retention slot 414 may be a cut-out extending from an edge of the second wick hole 412 into the wick recess 408. The retention slot 414 may be configured to allow a portion of the wick 550 to be slotted in the retention slot 414, which can further secure the wick 550 to the support plate 400. Having a retention slot 414 can provide an advantage of reducing the chances of the wick 550 moving from a desire position (e.g., with both ends of the wick 550 at an even length) when the grow pod 300 is assembled. In some implementations, both wick holes 410, 412 include retention slots 414. In this case, the wick hole 410 would resemble the wick hole 412 with the retention slot 414.

As shown in FIG. 3C, the wick holes 410, 412 can be at opposite corners and contained with the edges defined by the base support 406. In some implementations, wick holes 410, 412 can be configured to be close to the edges of the base support 406 to maximize the portion of the wick 550 positioned in the wick recess 408. Maximizing the amount of wick 550 in the wick recess 408 increases the surface area of the seed pad 500 in contact with the wick 550, which can increase the amount of liquid delivered to the seed pad 500 (e.g., to optimize for plant growth).

Referring back to FIG. 3A, the rim 404 extends perpendicularly from the edge(s) of the base 402. The rim 404 can be raised wall extending in a direction away from the reservoir system 200 when the grow pod 300 are positioned in the reservoir system 200. The rim 404 defines the periphery of the support plate 400. For example, the rim 404 can extend from a periphery of the base 402 in a direction away from the bottom side 403 of the base 402. The rim 404 is configured to contain the seed pad 500 in the grow pod 300 so that the seed pad 500 is prevented from sliding or moving around. For example, as shown in FIG. 2C, when the seed pad 500 is positioned on the base 402, the rim 404 extends around the seed pad 500. Once the plant sprouts from the seed pad 500, the rim 404 contains the base of the plant so that movement is limited. In some implementations, the rim 404 extends from the base 402 at approximately a 90-degree angle (e.g., between 85 degrees and 95 degrees). In other implementations, different angles are possible.

As shown in FIGS. 3C and 3D, the base support 406 extends from a bottom side 403 of the base 402. The base support 406 can be at least one wall extending from the bottom side 403. The base support 406 can be any suitable shape, such as a square, rectangle, circle, oval, and/or the like. In the illustrated implementation, the base support 406 is square-shaped, having four walls. For example, the four walls form the perimeter of the base support 406. The base support 406 is configured to interface with the reservoir system 200. For example, as discussed below, the base support 406 extends into a pod holder 214 of the reservoir system 200 in the plant-growing system 100. As such, the base support 406 is approximately the same shape and size or slightly smaller than the pod holders 214 of the reservoir system 200. In some cases, a square/rectangular shaped bottom support 206 may provide advantages, such as, for example, preventing the grow pods 300 from rotating withing the pod holders 214. Reducing the chances of rotation may be beneficial because unintended rotation of the pods could result in one or more of: damage to the plants, suboptimal light distribution to the plants, causing the weight of the plants to be distributed in an un-balanced arrangement, and/or the like. In some implementations, the base support 406 provides structural support for the support plate 400. For example, as the plants begin to grow (e.g., and retain more liquid or water), the weight of the plant material being supported by the support plate 400 can increase. Depending on the material used in the support plate 400, increased weight can cause the base 402 to deform or bend. In another example, the support plate 400 can experience material fatigue over time (e.g., based on changes to weight and/or temperature). In some cases, the base support 406 can reduce the chances of the base 402 bending or deforming by providing additional strength to the material of the support plate 400. In some implementations, the base 402 can be a first material (e.g., silicone) and the base support 406 can be a second material (e.g., plastic).

As shown in FIG. 3C, a portion of the base 402 extends further than the edges of the base support 406. For example, a portion of the base 402 is outside the perimeter of the base support 406. For example, the edges of the base support 406 are contained within the base 402. This arrangement allows the support plate 400 to be supported by a top surface (e.g., support plate 211) of the reservoir system 200 when the grow pods 300 are positioned in the pod holders 214.

In some implementations, the support plate 400 can include a plurality of additional holes in the base 402. For example, the support plate 400 can include a plurality of first holes 416, a plurality of second holes 418, and/or a plurality of third holes 420. More or less holes are possible. The holes 416, 418, and 420 can be any shape, such as, a square, rectangle, circle, oval, leaf, tear-drop, and/or the like. While different functions of the holes 416, 418, and 420 are described below, it is recognized than any of the holes 416, 418, and 420 can serve the same functions as any other hole 416, 418, and 420. For example, each hole 416, 418, and 420 can provide air flow to the seed pad 500 in the grow pod 300 and allow the seed pad 500 to be exposed to moisture from the reservoir system 200.

The plurality of first holes 416 can comprise four first holes 416. More or fewer first holes 416 are possible. The first holes 416 can be contained within an area of the base 402 defined by the base support 406 (see e.g., FIG. 3C). In some implementations, the first holes 416 provide access points for the roots of the plants (e.g., sprouted from the seed pad 500) to extend though the support plate 400. For example, as a plant begins to sprout from the seed pad 500, the roots of the plant can extent through the support plate 400 via the first holes 416 and towards the reservoir system 200. Having the first holes 416 positioned within the edges of the base support 406 can provide certain advantages. For example, roots extending through the first holes 416 can be initially contained within the base support 406, which may prevent the roots of one grow pod 300 from becoming tangled within the roots on another grow pod 300. Preventing root tangles is desirable so that the grow pods 300 can be removed from the reservoir system 200 without damaging any roots of any grow pods 300. In some cases, the roots of the plants do not extend through the support plate 400. For example, the roots can extend towards and/or attach to the wick 550.

The plurality of second holes 418 can comprise eight second holes 418. More or fewer second holes 418 are also possible. The second holes 418 can be located in the base 402 between the rim 404 and the edges of the base support 406. As such, the second holes 418 extend around a periphery of the base 402. The second holes 418 can promote an exchange of air through the support plate 400.

The plurality of third holes 420 can comprise two third holes 420. More or fewer third holes 420 are possible. The third holes 420 can be contained within an area of the base 402 defined by the base support 406 (see e.g., FIG. 3C). In some implementations, the third holes 420 can be located in near the corners of the base support 406. In some implementations, the third holes 420 can be used for a second wick (not shown) of the grow pod 300. For example, the third holes 420 can allow both ends of the second wick to extend through the support plate 400 and into the liquid when the grow pods 300 are positioned in the reservoir system 200. In some implementations, a second wick recess (not shown) extends between the third holes 420. Having a second wick in the grow pod 300 can provide an advantage of increasing the surface area of the seed pad 500 in contact with a wick. In some implementations, when the support plate 400 includes two wick recesses, the first wick recess may be deeper (e.g., further down in the base 402) than the second wick recess. Having wick recesses with varying depths can prevent a build up of wick material at the crossing points of the two wick (e.g., the center of the base 402) which could cause the seed pad 500 to not sit level on the support plate 400.

With reference to FIG. 2B, which illustrates the grow pod 300 with the wick 550 positioned in the support plate 400, the grow pod 300 can be assembled by first inserting the wick 550 into the support plate 400. The wick 550 can be threaded through the support plate 400 such that a first end of the wick 550 extends through the first wick hole 410 and the second end of the wick 550 extends through the second wick hole 412. In this arrangement, a central portion of the wick 550 is positioned in the wick recess 408. In some implementation, one or more portions of the wick 550 can be positioned in the retention slot 414. For example, a portion of the wick 550 can be threaded through the retention slot 414 and the second wick hole 412. In some implementations, two or more wicks 550 can be positioned in the wick recess 408 and extend through the wick holes 410, 412.

To finish assembling the grow pod 300, as shown in FIG. 2C, the seed pad 500 can be placed in the support plate 400 such that the seed pad 500 is contained within the rim 404. In this arrangement, the seed pad 500 is in contact with the wick 550 and the base 402 of the support plate 400. In some implementations, the wick 550 may have uninterrupted or continuous contact with the seed pad 500 when the grow pod 300 is assembled. For example, the wick 550 may contact the seed pad 500 at a first location and remain in contact with the seed pad 500 approximately along the center of the seed pad 500 before terminating contact at a second location. The first and second locations can be approximately defined by the first wick hole 410 and the second wick hole 412. In this example, the wick 550 does not break contact with the seed pad 500 between the first and second locations. The continuous contact may be uniform and uninterrupted across a diameter/chord of the seed pad 500. Continuous contact may provide benefits of even distribution of water along the entire seed pad 500, which may encourage an even distribution of water to the individual roots of the plant that grows from the seed pad 500. Depending on the amount of water retained in the reservoir system 200, the continuous contact may also prevent or limit uneven water distribution to the various roots of the plant being grown in the grow pod 300. In some examples, the wick 550 may contact the seed pad 500 at multiple different locations without continuous contact between the locations.

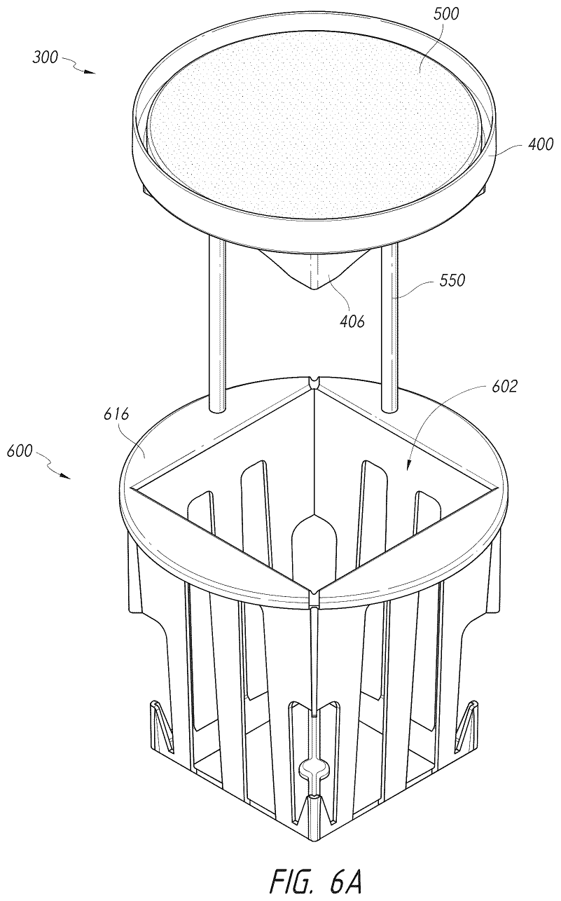

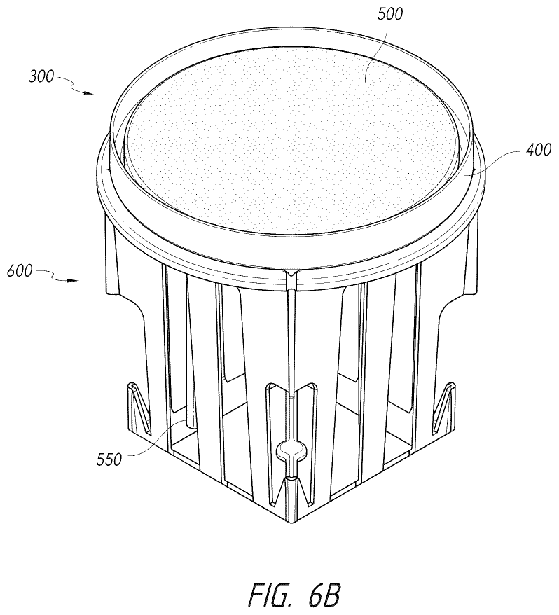

As shown in FIG. 2C, in some implementations, the wick 550 is self-contained within the grow pods 300. Once a grow pod 300 is assembled, the grow pod 300 can be moved as a single unit or system. For example, as described with reference to FIGS. 6A and 6B, grow pods 300 may be transported between different growing systems without damaging the plants or causing the components of the grow pods 300 to separate.

FIGS. 4A-4G illustrate various views of an example reservoir system 200, in accordance with some examples. FIG. 4A illustrates a perspective view of the reservoir system 200. FIG. 4B-4E illustrate a top, bottom, front, and side view of the reservoir system 200, respectively. The reservoir system 200 can include a reservoir base 202 and a top plate 204. The reservoir base 202 supports the top plate 204, while the top plate 204 receives and supports the grow pods 300 in the plant-growing system 100. The reservoir system 200 can be any suitable material or combination of materials, such as a metal, plastic, and/or the like. In some implementations, the reservoir base 202 and the top plate 204 can be one item (e.g., the reservoir base 202 and the top plate 204 can be molded together).

The reservoir base 202 is configured to hold/contain liquid (e.g., water, plant nutrients, a combination of water and/or plant nutrients, etc.). The liquid in the reservoir base 202 is provided to the grow pods 300 in plant-growing system 100 (e.g., via one or more wicks 550). The reservoir base 202 can be any suitable shape for containing liquid. The reservoir base 202 can include a bottom portion 206 and one or more side portions 208.

The bottom portion 206 provides a base support for reservoir system 200. As shown in at least FIGS. 4C-4E, the bottom portion 206 can be flat such that the reservoir system 200 sits level on a flat surface. In some implementations, the bottom portion 206 can include one or more grooves. For example, one or more grooves can help prevent the reservoir system 200 from sticking or sliding when place on a surface with water on it. The one or more side portions 208 can extend away from the bottom portion 206 in an approximately perpendicular direction (e.g., +/−5%, +/−10%, +/−15%, +/−5 degrees, +/−10 degrees, +/−15 degrees, or the like). In some examples, the one or more side portions 208 may extend away from the bottom portion in a non-perpendicular direction. For example, the one or more side portions 208 may be rounded, extend at an angle (e.g., +/−20-75 degrees), and/or the like. The bottom portion 206 is configured to reservoir system 200 and the liquid contained therein. The reservoir base 202 may be approximately circular, oval-shaped, rectangular, square-shaped, and/or the like. The reservoir base 202 may include rounded edges. For example, as shown in FIG. 4B, the one or more side portions 208 of reservoir base 202 may include two parallel straight side portions extending along the length of the reservoir base 202 and two rounded side portions.

FIG. 4F shows a cross-sectional front view of the reservoir system 200 across the line 4F-4F shown in FIG. 4B. FIG. 4G shows a cross-sectional side view of the reservoir system 200 across the line 4G-4G shown in FIG. 4B. As shown in at least these Figures, the reservoir base 202 can include a support rim 210. The support rim 210 can extend along a top edge of the one or more side portions 208. The support rim 210 is configured to support the top plate 204 of the reservoir system 200. For example, the top plate 204 can interface with the support rim 210 in the assembled reservoir system 200. In some implementations, the support rim 210 is configured to support a cover of the reservoir system 200, as described herein.

Referring back to FIG. 4B, the top plate 204 is configured to provide a support surface for the grow pods 300 such that the grow pods 300 can at least partially extend into the liquid in the reservoir base 202. The top plate 204 can include a support plate 211 and a plurality of pod holders 214. In some implementations, the top plate 204 is configured to interface with and be supported by the reservoir base 202 via the support plate 211. For example, an outer edge 212 of the support plate 211 can sit on the support rim 210 of the reservoir base 202. In this arrangement, a portion of the top plate 204 extends into the internal body of the reservoir base 202 and can be partially submerged in the liquid contained therein. The outer edge 212 of the top plate 204 can be the same shape as the one or more side portions 208 of the reservoir base 202. For example, in the illustrated example, the outer edge 212 includes two straight side edges and two rounded side edges.

The plurality of pod holders 214 are configured to receive the grow pods 300. For example, each pod holder 214 can receive and support one grow pod 300. The top plate 204 can include any number of pod holders 214. In some implementations, the top plate 204 includes 1 or more pod holders 214 (e.g., more than 1 pod holders 214, more than 5 pod holders 214, more than 10 pod holders 214, more than 20 pod holders 214, etc.). In the illustrated example, the top plate 204 includes 10 pod holders 214. In some implementations, the number of pod holders 214 can be based in part on the design of the reservoir base. For example, the reservoir base can be shaped like a triangle so that 3, 6, 10, or another number of pod holders 214 can be fit into the shape.

The pod holders 214 can be recessed portions in the support plate 211 extending towards the bottom portion 206 of the reservoir base 202 and positioned inwardly from the outer edge 212. The pod holders 214 can be any suitable shape (e.g., circular, square, oval, rectangular, triangular, and/or the like). In some implementations, the shape of the pod holders 214 can be determined by the shape of the base support 406 of support plate 400 used with the system and vice-versa so that the base support 406 can securely fit into the pod holders 214. In some implementations, the base support 406 may have a clearance fit or a transition fit with the pod holders 214. In the illustrated example, the reservoir system 200 is used with support plates 400 with square base supports 406. As such, the illustrated pod holders 214 are square-shaped.

The pod holders 214 can include side portions 216 and a bottom portion 218. The side portions 216 can extend from the support plate 211 in a direction towards the bottom portion 206 of the reservoir system 200. The side portions 216 are connected at their base to the bottom portion 218. As shown in FIGS. 4F and 4G, in some implementations, the side portions 216 can be tapered moving from the support plate 211 towards the bottom portion 218.

Having individual pod holders 214 for individual grow pods 300 can provide some benefits. For example, the side portions 216 and/or the bottom portion 218 allow each grow pod 300 to be partially isolated from adjacent grow pods 300. This arrangement can prevent or reduce the chances of the root systems of different grow pods 300 from contacting each other. When the root systems of different grow pods 300 come in contact, it may hinder the growth of one or both plants and/or may make the individual grow pods 300 more difficult to remove and transfer between plant growing systems.

Referring back to FIG. 4B, the bottom portions 218 of the pod holders 214 can include one or more holes 220. The one or more holes 220 can be cut-out(s) or channel(s) in the bottom portions 218. When the reservoir base 202 contains liquid, the one or more holes 220 are configured to allow the liquid to enter each of the pod holders 214 in the assembled reservoir system 200. The holes 220 can be any suitable shape for receiving liquid from the reservoir base 202, such as for example, circular, square, rectangular, ovals, slits, slots, and/or the like. When the liquid in the reservoir base 202 is above the height of the bottom portion 218, liquid is received into the pod holders 214 in the reservoir system 200 via each of the respective holes 220. In some implementations, the side portions 216 can include one or more holes for receiving liquid from the reservoir base 202. The side portion holes can be used in combination or alternatively to the one or more holes 220 in the bottom portion 218. For example, in some implementations, the pod holders 214 can include only bottom holes 220, only side holes, or a combination of both. In some implementations, the pod holders 214 may not include holes.

In some implementations, including the illustrated example, the top plate 204 can include one or more channels 222. The channels 222 can be recessed passages in the support plate 211 positioned between two adjacent pod holders 214. The channels 222 can be configured to promote an exchange of liquid between the pod holders 214. The depth of the channels 222 can be variable. For example, the channels 222 can be the same depth as the pod holders 214 (e.g., aligned with the bottom portions 218 so that the channel is as deep as the bottom portions 218) or at a depth between the bottom portions 218 and the top plate 214. As shown in FIG. 4G, in the illustrated example, the channels 222 are approximately the same depth as the pod holders 214. In some implementations, the top plate 204 may not include channels 222, and the pod holders 214 can be substantially isolated from each other. Including channels 222 in the top plate 204 can provide some benefits of allowing the fluid in the various pod holders 214 to be exchanged. While the various pod holders 214 share the same liquid source that can be received from the reservoir base 202 via the one or more holes 220, including channels 222 can increase the amount of fluid exchange between the pod holders 214 (e.g., which can prevent the liquid in an individual pod holder 214 from becoming stagnant). In some implementations, the channels 222 can transfer liquid from one pod holder 214 that includes no plant or a plant that consumes relatively little liquid to another pod holder 214 that includes a plant that consumes relatively more liquid. This transfer system may provide a particular benefit when the pod holders 214 do not include holes 220, or if only a portion of a plurality of pod holders 214 include holes 220. While FIG. 4B shows only certain pod holders 214 connected to each other via the channels 222, in the example, any adjacent pod holders 214 can be connected to each other via one or more channels 222.

In some implementations, the top plate 204 is configured to be supported by the reservoir base 202 without any additional connection mechanisms. Because the top plate 204 receives liquid from the reservoir base 202 (e.g., via the holes 220 in the pod holders 214), the top plate 204 generally will not float in the liquid of the reservoir base 202. In some implementations, the reservoir system 200 can included one or more mechanical systems for connecting the top plate 204 to the reservoir base 202. For example, the top plate 204 and/or reservoir base 202 may include snap fitting mechanisms, screw mechanisms, locking mechanisms, latch mechanism, and/or the like. In some cases, the top plate 204 may be configured to have a tight fit on top of and/or within the reservoir base 202. Having a connection system between the top plate 204 and the reservoir base 202 may provide benefits of securing the top plate 204 in place, particularly when the reservoir system 200 is being moved (e.g., by a user, or in a vehicle).

In some implementations, the reservoir system 200 can include a cover (not shown). The cover can be supported by one or both of the top plate 204 and/or the reservoir base 202. For example, the support rim 210 of the reservoir base 202 can support the cover. The cover may extend over the top plate 204 such that the pod holders 214 are under the cover. The cover can comprise any suitable material, such as plastic, metal, glass, or the like. In some implementations, the cover can be transparent or translucent such that light can access the grow pods 300 through the cover. In some implementations, the cover can be opaque such that light cannot access the grow pods 300 through the cover (e.g., in implementations where an alternative light source is used). In some implementations, the cover may include holes, slots, or cut-outs to allow air into the reservoir system 200. In some implementations, the reservoir system 200 can include a separate air filtration system. For example, the air filtration system can provide filtered air from an environment external to the reservoir system 200 to an internal environment of the reservoir system 200 (e.g., under the cover). In some implementations, the cover may not include holes, slots, or cut-outs so that air cannot pass into the reservoir system 200 (e.g., in implementations where the separate air filtration system is used). The cover may provide a benefit of creating an enclosed and controlled environment in the plant-growing system 100, which may promote the cultivation of the plants in various conditions. In some implementations, the cover can provide one or more of the following benefits: trapping heat in the plant-growing system 100, insulating the plant-growing system 100, diffusing light and/or UV filtering light received by the plant-growing system 100, providing a physical barrier of protection for the grow pods 300 and the plants, and/or protecting the plants and grow pods 300 from disease and pests.

In some implementations, the reservoir system 200 can include a light source. For example, the cover can include a light source. The light source can be one or a combination of: light emitting diodes (“LED”), LED grow lights, high-intensity discharge lights, fluorescent lights, plasma lights, ceramic metal halide lights, and/or the like. In some implementations, the power output of the light source can vary, depending on the specific requirements of the plants being cultivated in the plant-growing system 100. For example, the power output can be high-power or low-power depending on the plant species, growth stage, light intensity needs, scale of the plant-growing system 100, and/or the like. Having a light source within the cover can provide a benefit when the cover is opaque. In other implementations, the plant-growing system 100 can be used with an external light source, such as the sun, room lights, lamps, and/or the like.

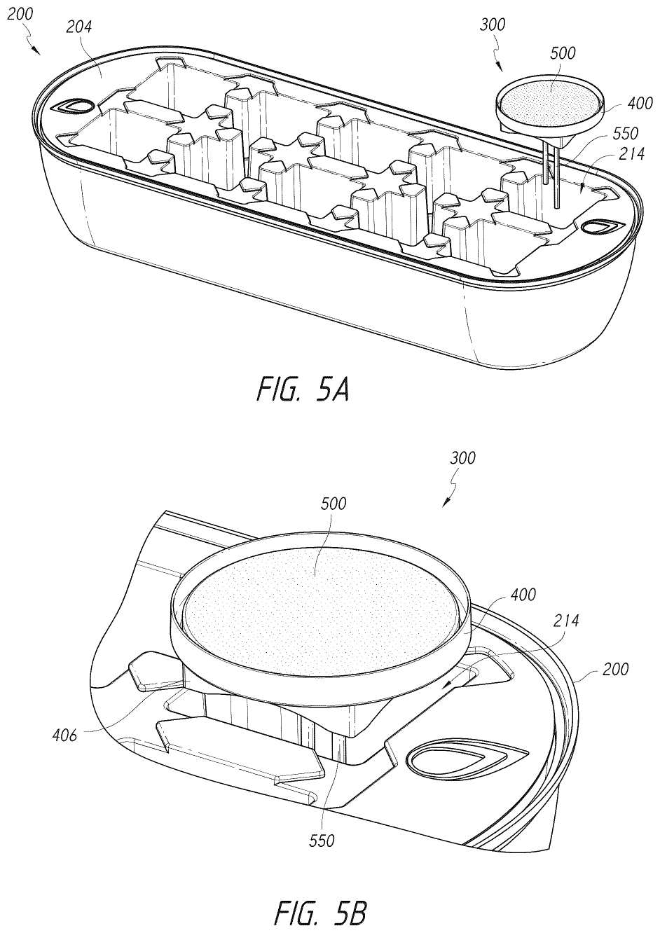

FIG. 5A illustrates an example grow pod 300 being inserted into a pod holder 214 of the reservoir system 200. FIG. 5B shows a close up view of FIG. 5A as the pod holder 214 is nearly fully inserted into the reservoir system 200. As shown, the grow pod 300 can be positioned such that the wick 550 extends into an individual pod holder 214. When the reservoir system 200 contains a minimally-sufficient level of liquid (e.g., at a height above the bottom portion 218 of the pod holders 214), the wick 550 can extend directly into the liquid of the reservoir system 200. In some implementations, the wick 550 may rest or touch the bottom portion 218 of the pod holders 214. In some implementations, the wick 550 may be suspended in the liquid in the pod holders 214 above the bottom portion 218. In some implementations, the wick 550 may float in the liquid in the bottom portion 218. The position of the wick 550 relative to the bottom portion 218 can depend on the length of the wick 550, the type of material used in the wick 550, the position of the wick 550 relative to the support plate 400, the depth of the bottom portion 218, and/or the like. When the grow pod 300 is fully inserted into the pod holder 214, the base support 406 extends into the pod holders 214 and may be in contact with the side portions 216 of the pod holders 214. The grow pod 300 is supported by the support plate 211 by the bottom side 403 of the support plate 400. As the base 402 extends around the base support 406 in the support plate 400, the area of the base 402 outside of the base support 406 can be supported by the support plate 211. As shown in FIG. 1A, multiple grow pods 300 can be placed in the reservoir system 200 in adjacent pod holders 214 without interference between adjacent support plates 400 of the grow pods 300. For example, FIG. 1B shows a top view of the plant-growing system 100. For illustrative purposes, the support plates 400 without the wick 550 and seed pad 500 are shown in FIG. 1B. While only three grow pods 300 are shown in FIG. 1A, it is recognized that each pod holders 214 of the reservoir system 200 can have a grow pod 300 inserted at the same time.

Once the grow pods 300 are placed in the liquid filled reservoir system 200, the ends of the wick 550 extend into and can be submerged in the liquid in the pod holders 214. Over time, the liquid can be transported up the wick 550 and into the grow pod 300 such that the seed pad 500 receives liquid due to contact with the wick 550. For example, the wick 550 can transport or deliver liquid through capillary action (e.g., using the inherent properties of cohesion and adhesion in the liquid and the wick 550 material). When the liquid in the reservoir system 200 is in contact with the wick 550, it is drawn upward against gravity due to the capillary forces, which can result in a continuous flow or movement of the liquid through the wick 550. This arrangement allows for hydration of the seed pad 500. As the seed pad 500 becomes hydrated, the dried biopolymer binder can dissolve and form a hydrating coat on the seeds. The seeds may then go through an imbibition period and germinate, with the roots of the seeds penetrating the base sheets 504 of the seed pad 500. As the plants continue to grow, the roots can travel through the support plate 400 (e.g., through the first holes 416) and further into the pod holders 214. The upward growth of stems of the plant can push the cover 502 of the seed pad 500 up and away from the support plate 400. After the cotyledons of the plant push out from the seed coat, the cover 502 can be easily removed from the grow pods 300, thus better exposing the new plants to light.

In some implementations, the plants from the grow pods 300 can be harvested as microgreens approximately 6-14 days from inserting the grow pods 300 into the reservoir system 200. However, the microgreen harvesting time can vary, depending on the liquid in the reservoir system 200, the growing conditions around the plant-growing system 100, the amount of light exposure, the type of plants, the number of seeds used, and/or the like. In some implementations, if baby greens are desired, additional plant nutrients may be helpful. For example, plant nutrients can be added to the reservoir system 200 to help facilitate growth of baby greens. In another example, the grow pod 300 with microgreen plants can be transferred as a unit to a second reservoir system 200 or an alternative growing system that include plant nutrients to encourage additional growth (e.g., the plant-growing systems described in the '729 publication). While plant nutrient may not be required, experiments have shown that older microgreens (e.g., approximately 14 days or older) may begin to turn yellow without exposure to certain plant nutrients. With the plant nutrients, the microgreens in the grow pods 300 can continue to grow and gain stem length and leaf surface area. In some implementations, the plants (e.g., baby greens) can be harvested from the plant-growing system 100 after approximately two additional weeks (e.g., 10-18 days) of exposure to the plant nutrients in the reservoir system 200. Harvesting the microgreens or baby greens can be accomplished by cutting the plants at the base of the stem near the seed pad 500.

### Additional Plant Growing Systems

At any point in time during the growth of the plants in the plant-growing system 100, the grow pod 300 can be transferred to another plant growing system, such as the plant-growing systems described in the '729 publication (referred to herein as secondary plant-growing system(s)). As described in the '729 publication, the secondary plant-growing systems can include a planting system including one or more modules. The modules can be configured to receive plant-growing containers than in turn receive seed receptacles. The seed receptacles can be configured to store a plant medium. The secondary plant-growing systems can provide light and water to the plants growing in the seed receptacles.

FIG. 6A illustrates an exploded view of an example support plate 400 and an example seed receptacle 600 of the secondary plant-growing systems, in accordance with some examples. FIG. 6B illustrates the support plate 400 inserted in the seed receptacle 600. The seed receptacle 600 can include a top cavity 602 and an upper portion 616. Further details and description of the seed receptacle 600 are provided in the '729 publication. The top cavity 602 can be the same size and shape or larger than the base support 406 of the support plate 400. For example, in the illustrated example, the top cavity 602 is square shaped.

When transferring the grow pod 300 with a plant (e.g., a microgreen or baby green) from the plant-growing system 100 to the secondary plant-growing system, the entire grow pod 300 can be removed from the reservoir system 200. The grow pod 300 can then be inserted into the seed receptacle 600 such that the base support 406 of the support plate 400 extends into the top cavity 602 of the seed receptacle 600. In this arrangement, the grow pod 300 can be supported by contact between the upper portion 616 of the seed receptacle 600 and the base 402 of the support plate 400. Once the grow pod 300 is secured in the seed receptacle 600, the seed receptacle 600 can be transferred to the secondary plant-growing system (e.g., placed in the plant-growing container and further inserted into a module of the planting system). It is recognized that the seed receptacle 600 can already be in position in the secondary plant-growing system when the grow pod 300 is transferred to the seed receptacle 600 of the secondary plant-growing system.

Having a non-circular base support 406 of the support plate 400 that is the same or a similar shape and size as the top cavity 602 of the seed receptacle 600 can provide certain benefits. For example, this configuration can limit unintentional movement or rotation of the support plate 400 relative to the seed receptacle 600. In some cases, growth of the plants can alter the weight distribution of the plants on the support plate 400, which could cause the support plate 400 to rotate relative to the seed receptacle 600 in the absence of the rotational limitation provided by contact between the non-circular base support 406 and the top cavity 602. Additionally, a user can rotate the position of the support plate 400 in the seed receptacle 600 with definitive degrees of rotation (e.g., 90-degrees for a square-shaped base support 406). Intentional rotation can allow the user to change which angle the plants in the support plate 400 receive light from and can alter the weight distribution of the plants as they continue to grow. Easy moveability of the grow pods 300 may provide the benefit of allowing grow pods 300 to be easily transferable between different growing systems (e.g., the plant-growing system 100 for a first growing stage and the secondary plant-growing system for a second growing stage). Easy moveability may also provide the benefit of preventing the root systems from different grow pods 300 from entangling. For example, because grow pods 300 are moveable, once the roots grow, the grow pods 300 can be transferred before any root interaction occurs between different grow pods 300 in the plant-growing system 100 (e.g., through the channels 222 or holes in the pod holders 214).

### Example Composition

Aspects of the disclosure relate to a composition for improving plant growth. In some cases, the composition is a hydroponic cultivation medium.

In some cases, the composition includes a biopolymer. In some cases, the biopolymer is a food grade biopolymer. In some cases, the composition includes two or more food grade biopolymers. In some cases, the food grade biopolymer is a binder. For example, the composition can be the biopolymer binder used in the seed pad 500 described herein. In some cases, the food grade biopolymer is selected from, but not limited, to methylcellulose, microcrystalline cellulose, carboxymethylcellulose, guar gum, locust bean gum, arabica gum, carrageenan, xanthan gum, pectin, alginate, inulin, pullulan, gellan gum, tara gum, glucomannan, curdlan, chondroitin sulfate, hyaluronic acid, pullulan, modified corn starch, wheat gluten, or combinations thereof. In some cases, the food grade biopolymer is carboxymethylcellulose. In some cases, the carboxymethylcellulose is an alkali metal carboxymethylcellulose, for example, sodium, calcium, potassium, or ammonium carboxymethylcellulose. In some cases, the composition includes about 0.5% to 3.0% by weight of the food grade biopolymer. In some cases, the composition includes 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0% by weight of the food grade biopolymer, or ranges including and/or spanning the aforementioned values. For example, the food grade biopolymer may be about 0.5% by weight of the composition. For example, the food grade biopolymer may be about 1.0% by weight of the composition. For example, the food grade biopolymer may be about 1.5% by weight of the composition. For example, the food grade biopolymer may be about 2.0% by weight of the composition. For example, the food grade biopolymer may be about 2.5% by weight of the composition. For example, the food grade biopolymer may be about 3.0% by weight of the composition.

In some cases, the composition includes calcium. In some cases, the calcium is from one or more sources of calcium. In some cases, the one or more sources of calcium is one or more calcium salts. In some cases, the one or more sources of calcium may be selected from, but not limited to, calcium carbonate, calcium citrate, calcium acetate, calcium propionate, calcium ascorbate, calcium sulfate, calcium lactate, calcium chloride, calcium phosphate, calcium gluconate, or combinations thereof. In some cases, the one or more sources of calcium may be calcium sulfate.

In some cases, the composition includes one or more amino acids. In some cases, the one or more amino acids includes natural amino acids, derivatives of amino acids, or combinations thereof. In some cases, the one or more amino acids is selected from, but not limited to, S-2-propenyl-L-cysteine sulfoxide (Alliin), S-methyl-L-cysteine sulfoxide (methiin), or combinations thereof.

In some cases, the composition includes one or more sulfates. In some cases, the one or more sulfates includes one or more sulfate salts. In some cases, the one or more sulfates includes, but is not limited to, aluminum sulfate, ammonium sulfate, calcium sulfate, manganese sulfate, magnesium sulfate, sodium bisulfite, sodium sulfate, potassium sulfate, or combinations thereof. In some cases, the composition includes calcium sulfate.

In some cases, the composition includes one or more glucosinolates. In some cases, the glucosinolates includes one or more of benzyl glucosinolate (glucotropaeolin), 4-methylsulfinylbutyl glucosinolate (glucoraphanin), allylglucosinolate (sinigrin), phenethylglucosinolate (gluconasturtiin), 4-(methylsufinyl)butyl isothiocyanate (sulforaphane), 2-hydroxybut-3-enylglucosinoate (progoitrin), indol-3-ylmethylglucosinolate (glucobrassicin), 4-hydroxyglucobrassicin, neoglucobrassicin, sinalbin, progoitrin, or combinations thereof. In some cases, the composition does not include a glucosinolates. For example, glucosinolates may be produced by the plants as they grow in response to, for example, a sulfate in the composition.

In some cases, the composition includes a seed. In some cases, the seed may include, but is not limited to, alfalfa, asparagus, anise, basil, beets, borage, brussels sprout, buckwheat, chard, cabbage, chia, chervil, chicory, chives, cilantro, cress, cucumber, dandelion, endive, fennel, flaxseeds, hemp, garlic, kale, komatsuna, lavender, leek, lemongrass, marjoram, mint, mustard, nutmeg, onion, orach, parsley, radicchio, radish, spinach, sorrel, sunflowers, tangerine, rutabaga, purslane, oregano, quinoa, parsley, pea, sage, sesame, poppy, pumpkin, sunflower, nasturtium, lovage, tarragon, thyme, turnip, marigold, wasabi, saltwort, wheatgrass, sorrel, and sambuca.

In some cases, the composition includes one or more antifungals or antimicrobials. In some cases, the one or more antifungals is a natural fungicide. In some cases, the one or more antifungals is a natural antimicrobial. In some embodiments, the one or more antifungals or antimicrobials may be selected from, but not limited to, hydrogen peroxide, copper-based fungicides, neem oil, cinnamon oil, garlic extract, citrus extracts, potassium bicarbonate, or a combination thereof. In some cases, the composition includes 0.1%, 0.2%, 0.3%, 0.4% 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% by weight of the one or more antifungals or antimicrobials, or ranges including and/or spanning the aforementioned values.

In some cases, the composition includes one or more growth factors. In some cases, the one or more growth factors may include one or more nutrients. In some cases, the one or more nutrients may be selected from, but not limited to, nitrogen, phosphorus, potassium, magnesium, iron, manganese, zinc, boron, copper, molybdenum, or a combination thereof. In some cases, the composition includes 0.001%, 0.05%, 0.1%, 0.2%, 0.3%, 0.4% 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 5%, 10%, 15%, 20% by weight of the one or more growth factors, or ranges including and/or spanning the aforementioned values.

In some cases, the composition includes one or more functional agents. In some cases, the one or more functional agent is humic acid. In some cases, the composition includes 0.05%, 0.1%, 0.2%, 0.3%, 0.4% 0.5%, 0.6%, 0.7%, 0.8%, 0.9%, 1.0%, by weight of the one or more functional agents, or ranges including and/or spanning the aforementioned values.

In some cases, the composition includes one or more liquids. In some cases, the liquid is water. In some cases, the composition includes 5%, 10%, 15%, 25%, 50%, 55%, 60%, 65%, 70%, 75%, 80%, 85%, 90%, 95%, 99% by weight of a liquid, or ranges including and/or spanning the aforementioned values. In some cases, the composition includes about 50% to 95% by weight of water.

In some cases, the composition is a solid granular composition. In some cases, the composition is a powdered composition. In some cases, the composition is a liquid composition. In some cases, the composition is a soluble crystal.

### Example Methods/Uses

Aspects of the disclosure relate to a method for improving hydroponic cultivation of a microgreen (e.g., the method 700 of FIG. 7). In some cases, the method 700 includes using a composition described herein as the biopolymer binder (e.g., the first biopolymer binder and/or the second biopolymer binder in the seed pad 500). In some implementations, the method 700 can include coating one or more seeds in a composition as described herein. In some implementations, the coating can be applied directly to the one or more seeds using one or more of a brush, a roller, or a spray. For example, the method 700 can be performed where the one or more seeds are coated in a composition as described herein. In some implementations, the one or more seeds can be coated in a composition described herein directly as an additional step. In some implementations, the one or more seeds may become coated in a composition described herein indirectly through exposure to the first biopolymer binder layer on the base and/or the second biopolymer binder layer on the cover 502. In some implementations, where the one or more seeds are coated as an additional step, the method 700 may not include applying the first biopolymer binder layer and/or the second biopolymer binder layer. In some cases, the method 700 can improve hydroponic cultivation. In some cases, the method includes placing a composition on a mat. In some cases, the method includes hydrating the mat. In some cases, the method includes covering the mat with a paper. In some cases, the method includes further applying a composition as described herein. In some cases, the method includes applying a biopolymer binder to the paper. In some cases, the method includes placing and pressing the paper onto the mat. In some cases, the composition further comprises one or more of bamboo, hemp, jute, polyfil, and wood shavings. In some embodiments, method further includes applying a biopolymer binder by using one or more of a brush, a roller, and a spray. In some cases, the method includes allowing the mat to dry for a first period of time. In some cases, the method includes cutting the full seeded mat into one or more shapes.

In some cases, a method is provided for optimizing growth of a microgreen. In some cases, the method includes coating a seed in a composition as described herein, placing the coated seed into a plant-growing system as described herein, and growing an edible plant from the seed. In some cases, the method includes placing a composition on a mat. In some cases, the method includes hydrating the mat. In some cases, the method includes covering the mat with a paper. In some cases, the method includes further applying a composition as described herein. In some cases, the method includes applying a biopolymer binder to the paper. In some cases, the method includes placing and pressing the paper onto the mat. In some cases, the composition further comprises one or more of bamboo, hemp, jute, polyfil, and wood shavings. In some embodiments, method further includes applying a biopolymer binder by using one or more of a brush, a roller, and a spray. In some cases, the method includes allowing the mat to dry. In some cases, the method includes cutting the full seeded mat into one or more shapes.

In some cases, the method 700 can produce one or more microgreens with improved microgreen texture. In some cases, the method 700 can produce one or more microgreens with an extended shelf-life. In some cases, the method 700 can produce one or more microgreens with improved nutritional value. The method 700 can further include placing the seed pad 500 with the coated one or more seeds into growing system 100 (e.g., as part of the grow pod 300), and growing an edible plant from the seed.

In some cases, including any implementations of the method 700, can further include adding 0.5% to about 3.0% w/w of a food grade biopolymer and a calcium or calcium salt to the seed pad 500. In some cases, the method can further include adding water to the seed pad 500 to form a hydrated seed pad 500. In some cases, the hydrated seed pad 500 forms a hydrogel upon hydration. In some cases, the food grade biopolymer is methylcellulose, microcrystalline cellulose, carboxymethylcellulose, guar gum, locust bean gum, arabica gum, carrageenan, xanthan gum, pectin, alginate, or combinations thereof. In some cases, the food grade biopolymer is carboxymethylcellulose. In some cases, the calcium or calcium salt is calcium, calcium sulfate, calcium lactate, calcium chloride, calcium phosphate, calcium gluconate, or combinations thereof. In some cases, the calcium salt is calcium sulfate. In some cases, the food grade biopolymer is coated onto the one or more seeds in the seed pad 500 directly or indirectly, as described herein. In some cases, the composition does not include a glucosinolates due to the natural production of glucosinolates by the plants in the grow pod 300. However, in some cases, the hydroponic cultivation medium further comprises a glucosinolates. In some cases, the one or more glucosinolates is benzyl glucosinolate (glucotropaeolin), 4-methylsulfinylbutyl glucosinolate (glucoraphanin), allylglucosinolate (sinigrin), phenethylglucosinolate (gluconasturtiin), 4-(methylsufinyl)butyl isothiocyanate (sulforaphane), 2-hydroxybut-3-enylglucosinoate (progoitrin), indol-3-ylmethylglucosinolate (glucobrassicin), 4-hydroxyglucobrassicin, neoglucobrassicin, sinalbin, progoitrin, or combinations thereof. In some cases, the composition further comprises one or more amino acids. In some cases, the one or more amino acids is S-2-propenyl-L-cysteine sulfoxide (Alliin), S-methyl-L-cysteine sulfoxide (methiin), or combinations thereof. In some cases, the hydroponic cultivation medium further comprises a sulfate. In some cases, the sulfate is magnesium sulfate, sodium sulfate, potassium sulfate, or combinations thereof. In some cases, the hydroponic cultivation medium further comprises one or more of antifungal, antimicrobial, growth factors, nutrients, functional agents, or combinations thereof. In some cases, the food grade biopolymer encapsulates the calcium or calcium salt. In some cases, the composition reduces the risk of bacterial or fungal rotting in the seed pad 500, the grow pod 300, and/or the reservoir system 200.

### Example 1—Food Grade Biopolymer for Improved Microgreens

In this example, the production of a seed pad 500 utilizing a composition described herein was produced and tested.

A seed pad 500 with a bamboo base sheet was produced utilizing a composition comprising carboxymethylcellulose (“CMC”) as a food grade biopolymer and serving as a binder, seed protective coating, and hydration layer upon re-wetting. The clear 1.5% CMC solution dissolved in potable water and was applied to the bamboo base sheet (hand brushed or rolled, or in an automated assembly line). Calcium sulfate was added to the hydrated CMC during the production of the seed pad 500. Upon hydration of the seed pad 500, it was believed that the CMC acted as a hydrogel entrapping the calcium sulfate for utilization by the sprouting seeds. Without wishing to be bound by theory, it was believed that the calcium sulfate contributed to a more ridged cell wall structure of the microgreens produced, reducing the risk of bacterial or fungal rotting while adding extra crunch to the texture of the microgreens. This effect was particularly profound in hydroponic cultivation resulting in more glucosinolates.

It was also determined that the composition could further act as a vehicle for adding nutrient, growth factors, antimicrobials, or antifungals, or functional agents that could improve plant nutrient properties, flavors texture, or desired plant growth parameters.

### Example 2—Hydrated Food Grade Biopolymer Binder & Customization for Improved Microgreens/Baby Greens

In this example, a composition with concentrations ranging from 1-2%, carboxymethylcellulose (“CMC”), was used to coat seeds in the seed pad 500 with various substances, such as antifungal agents, to improve the success rate of seeding soil. In the production of the seed pad 500—CMC served as a binder, seed protective coating, and hydration layer upon re-wetting. The clear CMC solution dissolved in potable water was applied to the seed pad 500 (e.g., to the base sheets 504 and/or the cover 502). The CMC solution can also serve as a vehicle for adding nutrients, growth factors, antimicrobials or antifungals, or functional agents that can improve plant nutrition properties, flavor, texture, or desired plant growth parameters. Added sulfate, a source of sulfur, has been shown to increase the levels of glucosinolates in brassica and other species. This effect is particularly profound in hydroponic cultivation, ranging from 56% more to 57-fold more glucosinolates with sulfate supplementation, as summarized by Falk et al. 2007. Glucosinolates are sulfur containing bioactive molecules with powerful anti-inflammatory and anti-cancer effects, improving their concentration in a fast-growing microgreen system would unlock new ways to deliver clinically significant doses of these powerful compounds to the masses. The following is incorporated by reference herein in its entirety for any and all purposes: Falk K L, Tokuhisa J G, Gershenzon J. The effect of sulfur nutrition on plant glucosinolate content: physiology and molecular mechanisms. Plant Biol (Stuttg). 2007 September; 9 (5): 573-81. doi: 10.1055/s-2007-965431. PMID: 17853357.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without user input or prompting, whether these features, elements or steps are included or are to be performed in any particular embodiment.

Unless the context clearly requires otherwise, throughout the description and the claims, the words “include,” “can include,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “and/or” in reference to a list of two or more items, covers all of the following interpretations of the word: any one of the items in the list, all of the items in the list, and any combination of the items in the list. Likewise, the term “or” in reference to a list of two or more items, covers all of the following interpretations of the word: any one of the items in the list, all of the items in the list, and any combination of the items in the list.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

Disjunctive language such as the phrase “at least one of X, Y, or Z,” unless specifically stated otherwise, is otherwise understood with the context as used in general to present that an item, term, etc., may be either X, Y, or Z, or any combination thereof (non-limiting examples: X, Y, or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

### EXAMPLE CLAUSES

Various examples of systems relating to a plant-growing system are found in the following clauses:
Clause 1. A plant-growing system comprising: a reservoir system comprising: a base configured to hold a liquid; and a top plate comprising at least one pod holder, the top plate supported by the base; and at least one pod configured to be removably inserted in the at least one pod holder, the at least one pod comprising: a support plate; a wick comprising a first end and a second end; and a seed pad, the wick positioned between the support plate and the seed pad.
Clause 2. The plant-growing system of clause 1, wherein the support plate comprises: a base plate comprising a top side and a bottom side; a rim extending from a periphery of the base plate away from the bottom side; and a base support extending from the bottom side.
Clause 3. The plant-growing system of clause 1 or clause 2, wherein the support plate further comprises: a first hole extending through the base plate; a second hole extending through the base plate; and a recessed portion in the base plate, the recessed portion extending between the first hole and the second hole, wherein the recessed portion is configured to receive the wick so that the first end extends through the first hole and the second end extends through the second hole.
Clause 4. The plant-growing system of any of clauses 1 to 3, wherein the support plate further comprises a plurality of third holes extending through the base plate, the plurality of third holes located within a perimeter defined by the base support.
Clause 5. The plant-growing system of any of clause 1 to 4, wherein the at least one pod holder comprises a recess in the top plate extending towards the base.
Clause 6. The plant-growing system of any of clauses 1 to 5, wherein the at least one pod holder comprises at least one side wall and a bottom portion.
Clause 7. The plant-growing system of any of clauses 1 to 6, wherein bottom portion comprises one or more holes, the one or more holes configure to allow liquid in the base to enter the at least one pod holder.
Clause 8. The plant-growing system of any of clauses 1 to 7, wherein the wick is configured to deliver liquid to the seed pad when the at least one pod is inserted into the at least one pod holder.
Clause 9. The plant-growing system of any of clauses 1 to 8, wherein the seed pad comprises: at least one base sheet; one or more plant seeds; and a cover, the one or more plant seeds positioned between the at least one base sheet and the cover.
Clause 10. The plant-growing system of any of clauses 1 to 9, wherein the seed pad further comprises a biopolymer binder.
Clause 11. The plant-growing system of any of clauses 1 to 10, wherein the cover comprises organic material.
Clause 12. The plant-growing system of any of clauses 1 to 11, wherein the at least one pod holder comprises a plurality of pod holders, wherein the top plate further comprise a plurality of channels extending between adjacent pod holders of the plurality of pod holders, wherein the plurality of channels allow liquid to be exchanged between the plurality of pod holders.
Clause 13. The plant-growing system of any of clauses 1 to 12, wherein the support plate is configured to hold the wick in contact with the seed pad.
Clause 14. The plant-growing system of any of clauses 1 to 13, wherein the liquid comprises water and one or more plant nutrients.
Clause 15. A pod for a plant-growing system, the pod comprising: a support plate configured to be removably inserted into a first plant-growing system; a wick comprising a first end and a second end; and a seed pad, the wick positioned between the support plate and the seed pad, and the seed pad is in physical contact with a portion of the wick.
Clause 16. The pod of clause 15, wherein the support plate comprises: a base plate comprising a top side and a bottom side; a rim extending from a periphery of the base plate away from the bottom side; and a base support extending from the bottom side.
Clause 17. The pod of clauses 15 or 16, wherein the support plate further comprises: a first hole extending through the base plate; a second hole extending through the base plate; and a recessed portion in the base plate, the recessed portion extending between the first hole and the second hole, wherein the recessed portion is configured to receive the wick so that the first end extends through the first hole and the second end extends through the second hole.
Clause 18. The pod of any of clauses 15 to 17, wherein the support plate further comprises a plurality of third holes extending through the base plate, the plurality of third holes located within a perimeter defined by the base support.
Clause 19. The pod of any of clauses 15 to 18, wherein the wick is configured to deliver a liquid to the seed pad when one or more of the first end or the second end is inserted into a source containing the liquid.
Clause 20. The pod of any of clauses 15 to 19, wherein the seed pad comprises: at least one base sheet; one or more plant seeds; and a cover, the one or more plant seeds positioned between the at least one base sheet and the cover.
Clause 21. The pod of any of clauses 15 to 20, wherein the seed pad further comprises a biopolymer binder.
Clause 22. The pod of any of clauses 15 to 21, wherein the cover comprises organic material.
Clause 23. The pod of any of clauses 15 to 22, wherein the support plate is configured to hold the wick in contact with the seed pad.
Clause 24. A method of assembling a seed pad, the method comprising: placing at least one base sheet on a surface; applying at least one layer of a first biopolymer binder to a first surface of the at least one base sheet; placing one or more seeds onto the first surface of the at least one base sheet and the first biopolymer binder layer; applying at least one layer of a second biopolymer binder to a first surface of a cover; and placing the cover onto the one or more seeds, wherein the first surface of the cover faces the first surface of the at least one base sheet.
Clause 25. The method of clause 24, further comprising: pressing the cover onto the at least one base sheet and the one or more seeds.
Clause 26. The method of clause 24 or clause 25, wherein the cover comprises organic material.
Clause 27. The method of any of clauses 24 to 26, wherein the application of the at least one layer of the first biopolymer binder and the at least one layer of the second biopolymer binder is performed using one or more of: a brush, a roller, and a spray.
Clause 28. The method of any of clauses 24 to 27, wherein the placing of the one or more seeds comprises placing the one or more seeds as a specific seeding density.
Clause 29. The method of any of clauses 24 to 28, wherein the placing of the one or more seeds comprises placing the one or more seeds by: hand, a drop seeder, or an auto-seeder.
Clause 30. The method of any of clauses 24 to 29, wherein the first biopolymer binder is the same as the second biopolymer binder.
Clause 31. The method of any of clauses 24 to 29, wherein the first biopolymer binder is different than the second biopolymer binder.
Clause 32. The method of any of clauses 24 to 31, further comprising waiting a first period of time to allow the first biopolymer binder and the second biopolymer binder to dry.
Clause 33. The method of any of clauses 24-32, further comprising: assembling a pod, wherein assembling the pod comprises: placing a wick on a support plate, the wick comprising a first end and a second end, the support plate comprising a first hole and a second hole, wherein the first end extends through the first hole and the second end extends through the second hole; and placing the seed pad onto a portion of the wick and the support plate, the portion of the wick positioned between the support plate and the seed pad.
Clause 34. The method of any of clauses 24 to 33, further comprising; inserting the pod into a pod holder of a reservoir system, the reservoir system comprising: a base configured to hold a liquid; and a top plate comprising the pod holder, the top plate supported by the base.
Clause 35. The method of any of clauses 24 to 34, wherein the wick is configured to provide liquid to the seed pad when the pod is inserted into the pod holder.
Clause 36. The method of any of clauses 24 to 35, wherein the liquid comprises water and one or more plant nutrients.
Clause 37. A composition comprising: a seed; 0.5% to 3.0% w/w of a food grade biopolymer; and a calcium or a calcium salt.
Clause 38. The composition of clause 37, wherein the seed is alfalfa, asparagus, anise, basil, beets, borage, brussels sprout, buckwheat, chard, cabbage, chia, chervil, chicory, chives, cilantro, cress, cucumber, dandelion, endive, fennel, flaxseeds, hemp, garlic, kale, komatsuna, lavender, leek, lemongrass, marjoram, mint, mustard, nutmeg, onion, orach, parsley, radicchio, radish, spinach, sorrel, sunflowers, tangerine, rutabaga, purslane, oregano, quinoa, parsley, pea, sage, sesame, poppy, pumpkin, sunflower, nasturtium, lovage, tarragon, thyme, turnip, marigold, wasabi, saltwort, wheatgrass, sorrel, and sambuca.
Clause 39. The composition of clause 37 or clause 38, wherein the food grade biopolymer is methylcellulose, microcrystalline cellulose, carboxymethylcellulose, guar gum, locust bean gum, arabica gum, carrageenan, xanthan gum, pectin, alginate, or combinations thereof.
Clause 40. The composition of clause 39, wherein the food grade biopolymer is carboxymethylcellulose.
Clause 41. The composition of any of clauses 37 to 40, wherein the calcium or calcium salt is calcium, calcium sulfate, calcium lactate, calcium chloride, calcium phosphate, calcium gluconate, or combinations thereof.
Clause 42. The composition of clause 41, wherein the calcium salt is calcium sulfate.
Clause 43. The composition of any of clauses 37 to 42, wherein the food grade biopolymer is coated onto the seed.
Clause 44. The composition of any of clauses 37 to 43, wherein the composition further comprises one or more glucosinolates.
Clause 45. The composition of clause 44, wherein the one or more glucosinolates is benzyl glucosinolate (glucotropaeolin), 4-methylsulfinylbutyl glucosinolate (glucoraphanin), allylglucosinolate (sinigrin), phenethylglucosinolate (gluconasturtiin), 4-(methylsufinyl)butyl isothiocyanate (sulforaphane), 2-hydroxybut-3-enylglucosinoate (progoitrin), indol-3-ylmethylglucosinolate (glucobrassicin), 4-hydroxyglucobrassicin, neoglucobrassicin, sinalbin, progoitrin, or combinations thereof.
Clause 46. The composition of any of clauses 37 to 45, wherein the composition further comprises a sulfate.
Clause 47. The composition of clause 46, wherein the sulfate is aluminum sulfate, ammonium sulfate, calcium sulfate, manganese sulfate, magnesium sulfate, sodium bisulfite, sodium sulfate, potassium sulfate, or combinations thereof.
Clause 48. The composition of any of clauses 37 to 47, wherein the composition further comprises one or more of antifungal, antimicrobial, growth factors, nutrients, functional agents, or combinations thereof.
Clause 49. The composition of any of clauses 37 to 48, wherein the composition further comprises bamboo, hemp, jute, polyfil, wood shavings, or a combination thereof.
Clause 50. The composition of any of clauses 37 to 49, wherein the composition further comprises water.
Clause 51. The composition of any of clauses 37 to 50, wherein the composition further comprises a wick.
Clause 52. The composition of any of clauses 37 to 51, wherein the composition further comprises a seed mat.
Clause 53. A method for improving hydroponic cultivation, comprising: creating a hydroponic cultivation medium by adding 0.5% to about 3.0% w/w of a food grade biopolymer and a calcium or calcium salt; adding at the hydroponic cultivation medium to at least one seed on a seed mat; and adding water to the at least one seed and the seed mat.
Clause 54. The method of clause 53, wherein the food grade biopolymer is methylcellulose, microcrystalline cellulose, carboxymethylcellulose, guar gum, locust bean gum, arabica gum, carrageenan, xanthan gum, pectin, alginate, or combinations thereof.
Clause 55. The method of clause 54, wherein the food grade biopolymer is carboxymethylcellulose.
Clause 56. The method of any of clauses 53 to 55, wherein the calcium or calcium salt is calcium, calcium sulfate, calcium lactate, calcium chloride, calcium phosphate, calcium gluconate, or combinations thereof.
Clause 57. The method of any of clauses 53 to 56, wherein the food grade biopolymer is coated onto the at least one seed.
Clause 58. The method of any of clauses 53 to 57, wherein the hydroponic cultivation medium further comprises a glucosinolates.
Clause 59. The method of clause 58, wherein one or more glucosinolates is benzyl glucosinolate (glucotropaeolin), 4-methylsulfinylbutyl glucosinolate (glucoraphanin), allylglucosinolate (sinigrin), phenethylglucosinolate (gluconasturtiin), 4-(methylsufinyl)butyl isothiocyanate (sulforaphane), 2-hydroxybut-3-enylglucosinoate (progoitrin), indol-3-ylmethylglucosinolate (glucobrassicin), 4-hydroxyglucobrassicin, neoglucobrassicin, sinalbin, progoitrin, or combinations thereof.
Clause 60. The method of any of clauses 53 to 59, wherein the hydroponic cultivation medium further comprises a sulfate.
Clause 61. The method of clause 60, wherein the sulfate is magnesium sulfate, sodium sulfate, potassium sulfate, or combinations thereof.
Clause 62. The method of any of clauses 53 to 61, wherein the hydroponic cultivation medium further comprises one or more of antifungal, antimicrobial, growth factors, nutrients, functional agents, or combinations thereof.
Clause 63. The method of any of clauses 53 to 62, wherein the hydroponic cultivation medium further comprises bamboo, hemp, jute, polyfil, wood shavings, or a combination thereof.
Clause 64. The method of any of clauses 53 to 63, wherein the hydroponic cultivation medium forms a hydrogel upon hydration.
Clause 65. The method of any of clauses 53 to 64, wherein the food grade biopolymer encapsulates the calcium or calcium salt.
Clause 66. The method of any of clauses 53 to 65, wherein the hydroponic cultivation medium reduces a risk of bacterial or fungal rotting.

What is claimed is:

1. A plant-growing system comprising:
a reservoir system comprising:
a base configured to hold a liquid; and
a top plate comprising at least one pod holder, the top plate supported by the base; and
at least one pod configured to be removably inserted in the at least one pod holder, the at least one pod comprising:
a support plate;
a wick comprising a first end and a second end; and
a seed pad, the wick positioned between the support plate and the seed pad.

2. The plant-growing system of claim 1, wherein the support plate comprises:
a base plate comprising a top side and a bottom side;
a rim extending from a periphery of the base plate away from the bottom side; and
a base support extending from the bottom side.

3. The plant-growing system of claim 1, wherein the support plate further comprises:
a first hole extending through the base plate;
a second hole extending through the base plate; and
a recessed portion in the base plate, the recessed portion extending between the first hole and the second hole, wherein the recessed portion is configured to receive the wick so that the first end extends through the first hole and the second end extends through the second hole.

4. The plant-growing system of claim 1, wherein the support plate further comprises a plurality of third holes extending through the base plate, the plurality of third holes located within a perimeter defined by the base support.

5. The plant-growing system of claim 1, wherein the at least one pod holder comprises a recess in the top plate extending towards the base.

6. The plant-growing system of claim 1, wherein the at least one pod holder comprises at least one side wall and a bottom portion.

7. The plant-growing system of claim 1, wherein bottom portion comprises one or more holes, the one or more holes configure to allow liquid in the base to enter the at least one pod holder.

8. The plant-growing system of claim 1, wherein the wick is configured to deliver liquid to the seed pad when the at least one pod is inserted into the at least one pod holder.

9. The plant-growing system of claim 1, wherein the seed pad comprises:
at least one base sheet;
one or more plant seeds; and
a cover, the one or more plant seeds positioned between the at least one base sheet and the cover.

10. The plant-growing system of any of claim 1, wherein the seed pad further comprises a biopolymer binder.

11. The plant-growing system of any of claim 1, wherein the cover comprises organic material.

12. The plant-growing system of any of claim 1, wherein the at least one pod holder comprises a plurality of pod holders, wherein the top plate further comprise a plurality of channels extending between adjacent pod holders of the plurality of pod holders, wherein the plurality of channels allow liquid to be exchanged between the plurality of pod holders.

13. The plant-growing system of claim 1, wherein the support plate is configured to hold the wick in contact with the seed pad.

14. The plant-growing system of any of claim 1, wherein the liquid comprises water and one or more plant nutrients.

15. A pod for a plant-growing system, the pod comprising:
a support plate configured to be removably inserted into a first plant-growing system;
a wick comprising a first end and a second end; and
a seed pad, the wick positioned between the support plate and the seed pad, and the seed pad is in physical contact with a portion of the wick.

16. The pod of claim 15, wherein the support plate comprises:
a base plate comprising a top side and a bottom side;
a rim extending from a periphery of the base plate away from the bottom side; and
a base support extending from the bottom side.

17. The pod of claim 15, wherein the support plate further comprises:
a first hole extending through the base plate;
a second hole extending through the base plate; and
a recessed portion in the base plate, the recessed portion extending between the first hole and the second hole, wherein the recessed portion is configured to receive the wick so that the first end extends through the first hole and the second end extends through the second hole.

18. The pod of claim 15, wherein the support plate further comprises a plurality of third holes extending through the base plate, the plurality of third holes located within a perimeter defined by the base support.

19. The pod of claim 15, wherein the wick is configured to deliver a liquid to the seed pad when one or more of the first end or the second end is inserted into a source containing the liquid.

20. The pod of claim 15, wherein the seed pad comprises:
at least one base sheet;
one or more plant seeds; and
a cover, the one or more plant seeds positioned between the at least one base sheet and the cover.
